(19) United States
(12) Patent Application Publication
(10) Pub. No.: US 2015/0310455 A1
(43) Pub. Date: Oct. 29, 2015

(54) Generation of an Image Regarding a Status Associated with a Patient

(71) Applicant: International Medical Records Systems, LLC, Dallas, TX (US)

(72) Inventor: Javier Vinals, Madrid (ES)

(73) Assignee: International Medical Records Systems, LLC, Dallas, TX (US)

(21) Appl. No.: 14/261,645

(22) Filed: Apr. 25, 2014

(51) Int. Cl. G06Q 30/02; G06Q 50/22

(52) U.S. Cl. CPC G06Q 30/0201; G06Q 50/22

(57) ABSTRACT

According to one embodiment, a system includes one or more processors operable to determine a plurality of individuals associated with a first health service provider. The processors are further operable to determine a plurality of second health service providers that are each associated with at least one of the individuals, and determine a status associated with each of the individuals. The processors are further operable to generate and communicate for display an image based on the individuals, the second health service providers, and the statuses associated with the individuals. The image comprises a plurality of sections that each represent one of the individuals. Each section includes an indication in the section of the status associated with the one of the individuals. The image further comprises a plurality of groupings of one or more of the sections. Each grouping represents one of the second health service providers.

### TECHNICAL FIELD

This disclosure relates generally to the field of medicine and more specifically to generation of an image regarding a status associated with a patient.

### BACKGROUND

Traditionally, when a patient visits a new health service provider (e.g., a doctor), the doctor may not have access to the patient's previous medical information (other than what the patient can remember). Furthermore, even when a patient's medical information may be in electronic form in a health information exchange (HIE) system, the doctor still may not have access to the patient's previous medical information for various reasons. As such, traditional healthcare systems may be deficient. Additionally, traditional health care systems may further be deficient with regard to the referral of patients between doctors.

### SUMMARY OF THE DISCLOSURE

According to one embodiment, a system includes one or more processors operable to determine a plurality of individuals associated with a first health service provider. The processors are further operable to determine a plurality of second health service providers that are each associated with at least one of the individuals, and determine a status associated with each of the individuals. The processors are further operable to generate and communicate for display an image based on the individuals, the second health service providers, and the statuses associated with the individuals. The image comprises a plurality of sections that each represent one of the individuals. Each section includes an indication in the section of the status associated with the one of the individuals. The image further comprises a plurality of groupings of one or more of the sections. Each grouping represents one of the second health service providers.

Certain embodiments of the disclosure may provide one or more technical advantages. For example, by providing an image based on individuals, second health service providers, and statuses associated with the individuals, information associated with one or more patient referrals may be more easily and quickly understood by a first health service provider. As another example, by providing an image that includes an indication of a status associated with the one of the individuals, the statuses associated with individuals (such as patients) may be more easily and quickly understood by a first health service provider.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system that manages medical information according to one embodiment of the disclosure;

FIG. 2A illustrates an example of a clinical packet according to one embodiment of the disclosure;

FIG. 2B illustrates an example of a report according to one embodiment of the disclosure;

FIG. 3 illustrates an example of a graphical user interface according to one embodiment of the disclosure;

FIG. 4 illustrates another example of a graphical user interface according to one embodiment of the disclosure;

FIG. 5 illustrates another example of a graphical user interface according to one embodiment of the disclosure;

FIG. 6 illustrates a method for management of medical information according to one embodiment of the disclosure;

FIGS. 7A-7B illustrate another example of a graphical user interface according to one embodiment of the disclosure; and

FIG. 8 illustrates a method for generation of an image regarding statuses associated with patients according to one embodiment of the disclosure.

### DETAILED DESCRIPTION OF THE DRAWINGS

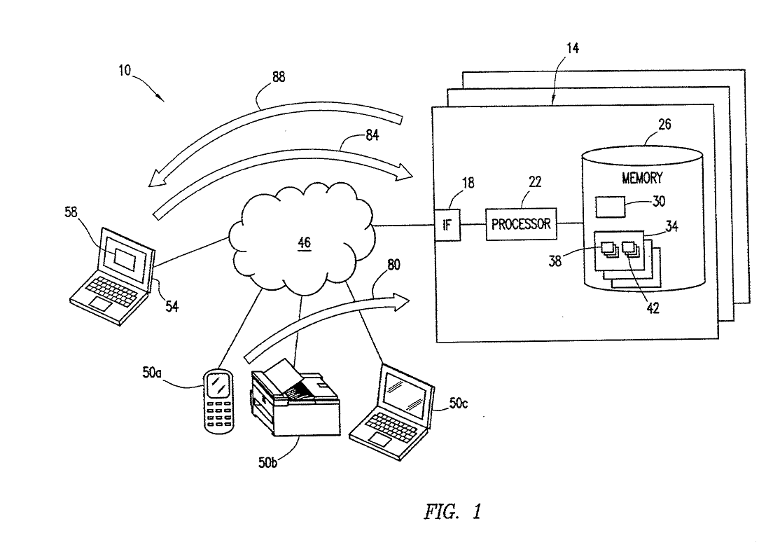

Embodiments of the present disclosure are best understood by referring to FIGS. 1-8 of the drawings, like numerals being used for like and corresponding parts of the various drawings.

FIG. 1 illustrates a system 10 that manages medical information according to one embodiment of the disclosure. As illustrated, system 10 includes a management device 14 that receives clinical packets from communication devices 50. Based on these clinical packets, management device 14 may generate medical information for one or more patients. Furthermore, upon receiving a request to view medical information for a particular patient, management device 14 may determine whether the requestor has been given one or more permission levels by the patient. If so, management device 14 may communicate at least a portion of the medical information for view by the requestor. As such, system 10 may allow medical information for a patient to be generated based on clinical packets received from any number of communication channels (e.g., e-mail, voicemail, video, fax, cloud services, SMS, MMS, etc.) and may further allow portions of the medical information for a patient to be viewed by a requestor if the requestor has been given an associated permission level from the patient. Therefore, the health service provider may be able to access the patient's medical information.

Traditionally, healthcare systems may be deficient in their ability to provide access to medical information when needed. For example, a patient (e.g., Patient A) may visit a hospital due to a particular ailment. If the hospital is in a different city from which the patient lives, the patient may be treated by a doctor (e.g., Doctor B) who has never treated the patient before. Furthermore the doctor may not have access to the patient's previous medical information. Thus, the doctor may be required to rely only on the patient's memory regarding their previous medical information (e.g., previous ailments, allergies, current and past medications, etc.). Additionally, when the patient subsequently visits their normal doctor (e.g., Doctor A), that doctor may not have any access to the medical information associated with the patient's treatment by Doctor B.

In order to attempt to solve this lack of access to medical information, some traditional healthcare systems may utilize electronic medical records (EMRs) and HIE systems that may be designed to provide better access to medical information. Unfortunately, these traditional healthcare systems may also be deficient. First, different HIE systems may be incompatible with each other. As such, if a portion of a patient's medical information is stored on a first HIE system and another portion of the patient's medical information is stored on a second HIE system, the doctor may be required to access both systems in order to access all of the information. Furthermore, the patient may be identified by a different identifier on each HIE system, which may further prevent incorporation of all of the medical information. For example, if a first HIE system identifies the patient as patient 718 (e.g., assigned by a first hospital) while the second HIE system identifies the patient as patient 290 (e.g., assigned by the patient's family doctor), incorporation of the medical information into a single system may create two different patients (e.g., patient 718 and patient 290), as opposed to the one patient the records actually refer to. Second, before the doctor can even attempt to access different HIE systems, the doctor may be required to install different HIE-specific software on their computer systems. This can be both costly and cumbersome. Third, the HIE systems may prevent proper patient referrals. For example, if a doctor wanted to refer their patient to a specialist, the doctor would have to know the HIE system that the specialist is using, and the doctor would also have to upload the relevant medical information to that particular HIE system (in addition to uploading it to their own HIE system). If the doctor was unable (or unwilling to do so), the specialist would not have access to the proper medical information when the patient arrives for treatment.

One or more of these deficiencies, however, may be addressed by system 10 of FIG. 1. As illustrated, system 10 includes management device 14. Management device 14 may represent any components that manage medical information for one or more patients, and may be implemented using any suitable combination of hardware, firmware, and software. Management device 14 may include a network server, any remote server, a mainframe, a host computer, a workstation, a web space server, a personal computer, a file server, or any other device operable to manage medical information for one or more patients. The functions of management device 14 may be performed by any combination of one or more servers or other components at one or more locations. If the module is a server, the server may be a private server, and the server may be a virtual or physical server. The server may include one or more servers at the same or remote locations. Also, management device 14 may include any component that functions as a server.

Although FIG. 1 illustrates system 10 as only including one management device 14, system 10 may include any suitable number of management devices 14. For example, system 10 may include more than one management device 14 (e.g., two, three, four, ten, 100, 1,000, 10,000, 100,000, 250,000, one million management devices 14, etc.). Furthermore, each of these management devices 14 may operate together as a single information system (e.g., a cloud-based management system).

As illustrated, management device 14 includes a network interface 18, a processor 22, and a memory 26. Network interface 18 may represent any device operable to receive information from network 46, transmit information through network 46, perform processing of information, communicate to other devices, or any combination of the preceding, and may be implemented using any suitable combination of hardware, firmware, and software. For example, network interface 18 may receive information from a communication device 50. As another example, network interface 18 may communicate medical information for display on a user device 54. Network interface 18 may represent any port or connection, real or virtual, including any suitable hardware and/or software, including protocol conversion and data processing capabilities, to communicate through a local area network (LAN), a metropolitan area network (MAN), a wide area network (WAN), a local, regional, or global communication or computer network, such as the Internet, a wireline or wireless network, an enterprise intranet, or other communication system (or a combination of these systems) that allows management device 14 to exchange information with network 46, communication devices 50, user device 54, or other components of system 10.

Processor 22 communicatively couples to network interface 18 and memory 26, and controls the operation and administration of management device 14 by processing information received from network interface 18 and memory 26. For example, processor 22 executes management device application 30 to control the operation of management device 14. Processor 22 may be a programmable logic device, a microcontroller, a microprocessor, any processing device, or any combination of the preceding.

Memory 26 stores, either permanently or temporarily, data, operational software, or other information for processor 22. Memory 26 includes any one or a combination of volatile or non-volatile local or remote devices suitable for storing information. For example, memory 26 may include random access memory (RAM), read only memory (ROM), magnetic storage devices, optical storage devices, databases (such as a Structured Query Language (SQL) database), or any other information storage device or a combination of these devices. While illustrated as including particular modules, memory 26 may include any information for use in the operation of management device 14.

As illustrated, memory 26 includes management device application 30 and one or more patient records 34. Management device application 30 may represent any suitable set of instructions, logic, or code embodied in a computer readable storage medium and operable to facilitate the operation of management device 14.

Patient records 34 may represent records of medical information for one or more patients. For example, a first patient record 34 may represent medical information records for a first patient (e.g., Patient A) while a second patient record 34 may represent medical information records for a second patient (e.g., Patient B). Memory 26 may store any number of patient records 34. For example, memory 26 may store patient records 34 for one patient, two patients, ten patients, 100 patients, 1,000 patients, 10,000 patients, 100,000 patients, 250,000 patients, one million patients, ten million patients, one hundred million patients, or any other number of patients.

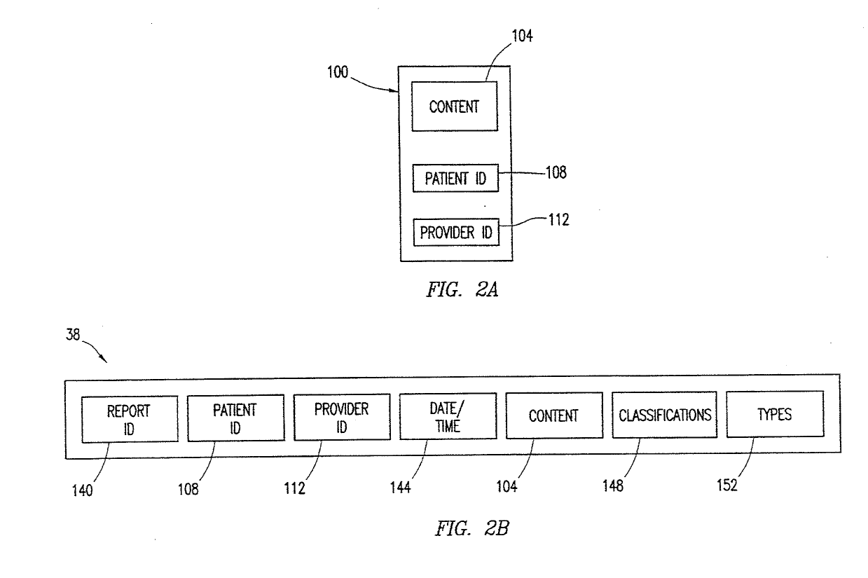

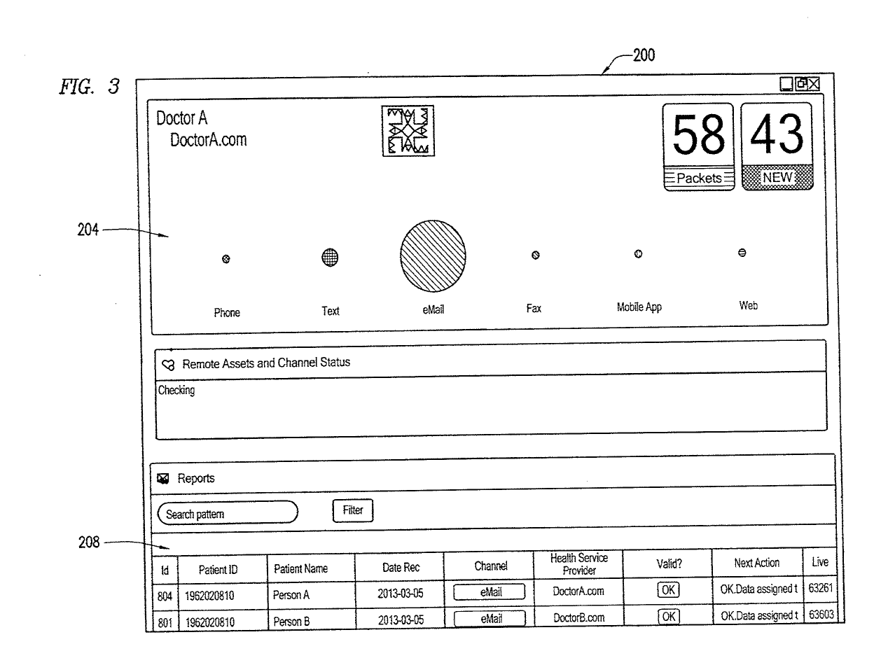

A patient record 34 may include one or more reports 38 and one or more permission levels 42. Report 38 may represent a report associated with the health of the patient. For example, if a patient broke his leg on Jan. 15, 2014, the information associated with that broken leg may be stored as one or more reports 38. In such an example, a first report 38 may include x-rays of the broken leg, a second report 38 may include medications given to the patient, a third report 38 may include information associated with the recovery of the patient, a fourth report 38 may include a further x-ray of the leg after it is healed, etc. Furthermore, although this information may be included in different reports 38, such information may also be included in a single report 38. For example, the information may be included in a single report 38 when the information is from the same health event (e.g., a health event related to a broken leg). One or more reports 38 for a patient may be an EMR provided by one or more health service providers (e.g., a doctor, a hospital, a medical testing unit, a psychiatrist, a dietician, a personal trainer, a health insurance company, any other provider of health services, or any combination of the preceding). Additionally, one or more reports 38 may be a personal health record (PHR) provided by the patient himself (e.g., the patient's family history, a new diet the patient is trying, allergies known to the patient, symptoms of an ailment, information related to previous medical related events (e.g., the patient may provide a scanned copy or a summary of a previous report or test result generated by a health service provider), data obtained by a monitoring sensor or device (e.g., temperature recording, pulse recording, physical constants recording, etc.), any other information that may be provided by the patient, or any combination of the preceding). Reports 38 for a particular patient may make up the medical information of the patient. For example, by reviewing one or more reports 38, a health service provider may be able to understand the medical information of the patient. An example of a report 38 is discussed further below with regard to FIG. 2B.

Permission levels 42 may represent permissions given by a patient so that at least a portion of the patient's medical information may be accessed. Permission levels 42 may be given by a patient to one or more health service providers so that the health service provider may access at least a portion of the patient's medical information. For example, if a particular doctor is the patient's main doctor, the patient may give that doctor full permission to access all of the patient's medical information. As another example, if the patient is visiting a dietician, the patient may only give the dietician the ability to access medical information associated with the patient's diet and food-related health. In such an example, the dietician may not be able to access medical information regarding a previous broken leg, previous psychiatric exams, or any other medical information not associated with the patient's diet and food-related health. As such, permission levels 42 may allow a patient to restrict what medical information a health service provider is able to access. Permission levels 42 may also be given by a patient to one or more family members, friends, and/or any other person or entity. As such, the patient may have the ability to allow family members (or anyone else) to access at least a portion of the patient's medical information.

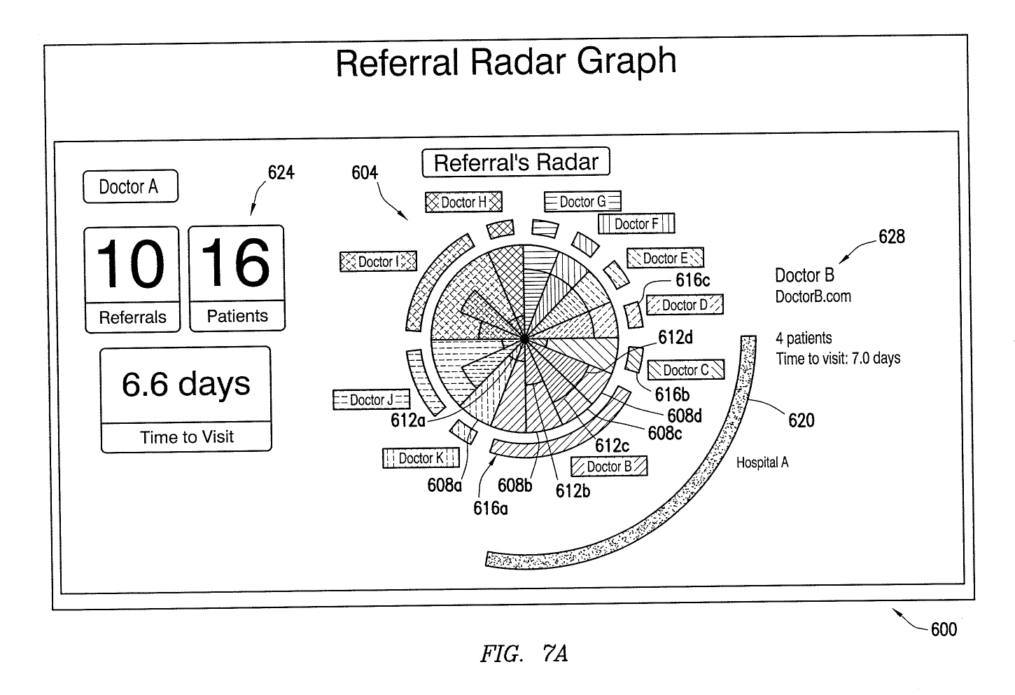

Although permission levels 42 may allow a patient to restrict what medical information a health service provider is able to access, permission levels 42 may not prevent (or may prevent) a health service provider from being able to see that a patient has a particular report 38 (even though the health service provider may not be able to access the report 38 or access any of the information in the report 38). For example, even when a health service provider does not have permission to access particular medical information (e.g., particular reports 38), the restricted reports may still be viewable by the health service provider as “blinded reports.” These blinded reports may appear as empty boxes (or any other type of GUIs) that do not include any medical information (or only very generic medical information). However, the health service provider may be able to click on (or otherwise select) the blinded report in order to request permission from the patient for access to that blinded report, as is described below with regard to FIG. 6.

A permission level 42 may allow the grantee (e.g., a health service provider, a family member, etc) of the permission level to access at least a portion of the patient's medical information. Additionally, the permission level 42 may also provide access to employees, agents, and/or consultants of the grantee. For example, if the patient gives a hospital permission to access a portion of the patient's medical information, any of the doctors, nurses, technicians, consultants, and/or any other employee of the hospital may be able to access that portion of the patient's medical information. As another example, if the patient gives a particular doctor permission to access a portion of the patient's medical information, the doctor may allow other doctors to access that information for purposes of consultation in the treatment of the patient. Furthermore, the extent to which a permission level 42 provides access to employees, agents, and/or consultants of the grantee may be specifically tailored by the patient and/or the grantee. For example, the patient may tailor the permission level 42 to give access to only the doctor (e.g., no access to employees, etc.). As another example, the patient and/or the hospital may tailor the permission level 42 to give the full access of permission level 42 to medically relevant employees (e.g., doctors, nurses, etc.), billing-level access to billing relevant employees (e.g., accountants), and no access to other employees (e.g., janitors). As a further example, the patient and/or the hospital may tailor the permission level 42 to give the full access of permission level 42 to particular doctors (e.g., doctors currently treating the patient), while giving only partial access of permission level 42 and/or no access to other doctors (e.g., doctors not currently treating the patient).

A permission level 42 may include any level of access of a patient's medical information. Examples of permission level 42 may include full permission (e.g., where the health service provider may have full access to all of the patient's medical information), classification-specific (or health event-specific) permission (e.g., where the health service provider may only have access to medical information associated with a particular classification (or a particular health event) (e.g., “left leg”, “broken bone”, “diabetes”, “psychiatric evaluation”, “dental record”, “check/routine”, “isolated symptom”, “drug related data”, “personal episode”, etc.), type-specific permission (e.g., a radiologist may only have access to medical information classified as an x-ray), provider-specific permission (e.g., a dietician may only have access to medical information associated with the patient's diet and food-related health, an insurance company may only have access to medical information associated with billing, etc.), report-specific permission (e.g., a doctor may only have access to a particular report 38, or particular reports 38), no permission (e.g., which may prevent the health service provider from accessing any medical information about the patient), any other level of access of a patient's medical information, or any combination of the preceding.

A permission level 42 may be expressly given by the patient, or may be implicitly given by the patient. For example, the patient may expressly give a particular health service provider (e.g., a family doctor) full permission to access all of the patient's medical information by signing particular documents at the doctor's office, expressly indicating the permission level 42 to management device 14 (by e-mail, voice message, video, clicking on a permission level button on a graphical user interface window provided by management device 14), any other method of expressly giving permission, or any combination of the preceding. As another example, the patient may implicitly give a permission level 42 by visiting a hospital during an emergency, receiving one or more services from a health service provider, any other method of implicitly giving permission, or any combination of the preceding. Furthermore, a permission level 42 may have a duration for which it is valid. As an example, a patient may give a health service provider a particular permission level 42 that will last for a particular amount of time (e.g., one hour, one day, one week, etc.), or that will last until expressly revoked by the patient. As another example, an implied permission level 42 may only have a duration needed to provide medical services for the patient (e.g., one hour, one day, one week, etc). In such an example, after the duration is over, the permission level 42 may no longer be valid, and the health service provider may not be able to access the patient's medical information.

Network 46 may represent any network operable to facilitate communication between the components of system 10, such as management device 14, communication devices 50, and user device 54. Network 46 may include any interconnecting system capable of transmitting audio, video, signals, data, messages, or any combination of the preceding. Network 46 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

Communication device 50 may represent any components for communicating one or more clinical packets to management device 14, and may be implemented using any suitable combination of hardware, firmware, and software. Communication device 50 may include a personal computer, a work station, a laptop, a wireless or cellular telephone, an electronic notebook, a tablet, a television, a personal digital system, a fax machine, a digital camera, any other communication device (wireless, wireline, or otherwise) capable of communicating a clinical packet to management device 14, or any combination of the preceding. Communication device 50 may comprise a user interface, such as a display, a microphone, keypad, or other appropriate equipment usable by a user (e.g., a patient, a health service provider, any other type of user), such as a sensor or device used to obtain information from the user and provide it to communication device 50 (e.g., fitness bands, pedometers, thermometers, blood pressure monitors, pulsometers, global positioning system (GPS) tracking systems, activity tracking systems), in order to communicate a clinical packet to management device 14. Furthermore, communication device 50 may also allow a user to communicate any number of clinical packets to management device 14. For example, a health service provider may have their own EMRs stored in their own database. In such an example, the health service provider may utilize communication device 50 to transmit (or connect) their database of records to management device 14. One or more of these records may be communicated as a clinical packet. As such, the health service provider may incorporate their own database of records into management device 14 in a simple and efficient manner.

Communication device 50 may be associated with one or more communication channels. A communication channel may represent a channel used by communication device 50 in order to communicate a clinical packet to management device 14. Examples of communication channels may include e-mail, voicemail, video, fax, cloud services, SMS, MMS, twitter, a social network and/or messaging system (e.g., WHATSAPP, etc.), Bluetooth, near field communications interface, communication via an application (App) installed on a communication device 50, any other communication channel, or any combination of the preceding. As an example, in order to transmit a particular EMR to management device 14, a doctor may use a wireless telephone to take a picture of a prescription written by the doctor, and may text or e-mail the picture as a clinical packet to management device 14. As a further example, the doctor may describe the prescription in a voicemail to management device 14 (which may be transcribed into text). As a further example, the doctor may describe and film the prescription in a video communicated to management device 14 (which may be transcribed into text and/or segmented into individual images of the prescription). As another example, the doctor may fax the prescription to management device 14. Content of the clinical packets communicated by communication device 50 may be text, images, video, audio, any type of document that stores information (text files containing database views, files that contain information coming from any medical device (such as a blood pressure monitor, etc.)), any other content, or any combination of the preceding.

Although FIG. 1 illustrates system 10 as including three communication devices 50 (communication device 50a, communication device 50b, and communication device 50c), system 10 may include any other number of communication devices 50. For example, system 10 may include less than three communication devices 50 (e.g., one or two communication devices 50) or more than three communication devices 50 (e.g., four, ten, 100, 1,000, 10,000, 100,000, 250,000, one million communication devices 50, etc.).

User device 54 may represent any components for displaying information received from management device 14, and may be implemented using any suitable combination of hardware, firmware, and software. User device 54 may include a personal computer, a workstation, a laptop, a wireless or cellular telephone, an electronic notebook, a tablet, a television, a personal digital assistant, or any other device (wireless, wireline, or otherwise) capable of receiving, processing, storing, and/or communicating information with other components of system 10 in order to display information received from management device 14. User device 54 may further allow a user to request information from management device 14 and/or provide information to management device 14. For example, in order to access a particular patient's medical information, a user may provide one or more requests for that medical information to management device 14. As another example, in order to add medical information or update medical information, a user may provide one or more inputs to management device 14. User device 54 may comprise a user interface, such as a display, a microphone, keypad, or other appropriate terminal equipment usable by a user.

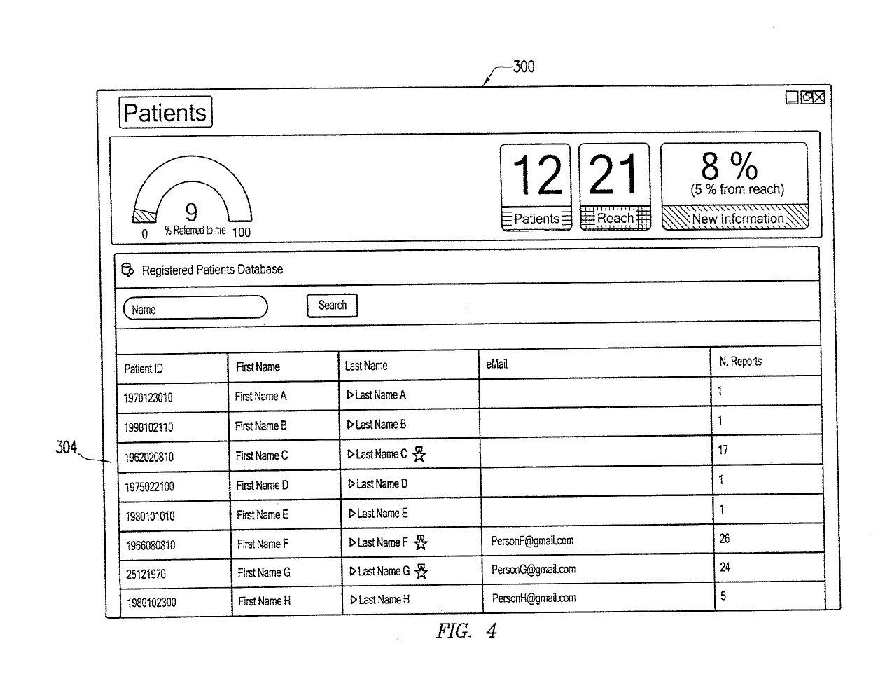

User device 54 may display a graphical user interface 58 in order to allow a user to display the information received from management device 14, request information from management device 14, and/or provide inputs to management device 14. Examples of graphical user interface 58 are discussed further below with regard to FIGS. 3-5 and 7.

Although FIG. 1 illustrates system 10 as including only one user device 54, system 10 may include any other number of user devices 54. For example, system 10 may include more than one user device 54 (e.g., four, ten, 100, 1,000, 10,000, 100,000, 250,000, one million user devices 54, etc.). Furthermore, although FIG. 1 illustrates management device 14, communication devices 50, and user device 54 as separate components, two or more of the management device 14, communication devices 50, and user device 54 may be the same component. For example, communication device 50a and user device 54 may be the same device. In such an example, a user may view medical information for a patient at the same device that is used to transmit a clinical packet to management device 14. As another example, user device 54 and management device 14 may be the same device. In such an example, a user may view medical information for a patient at the same device that manages the medical information.

In an example of operations of system 10, in order to develop medical information for a patient, a user may transmit a clinical packet to management device 14 via clinical packet transmission 80. The user may be a patient, a health service provider (e.g., a doctor, a hospital, a medical testing unit, a psychiatrist, a dietician, a personal trainer, a health insurance company, any other provider of health services, or any combination of the preceding), or any other user. The clinical packet may include content associated with the health of the patient. For example, the content may be an EMR provided by a health service provider. In such an example, the content may include any information that may be provided by a health service provider about the patient (e.g., an x-ray, a prescription, a health diagnosis, a recommendation made to the patient, test data, a patient referral, results of a psychiatric exam, notes from an examination of the patient, etc.). Furthermore, in such an example, the clinical packet may be communicated by a health service provider using a communication device 50. As another example, the content may be a PHR provided by the patient. In such an example, the content may include any information that may be provided by the patient about himself (e.g., the patient's family history, a new diet the patient is trying, allergies known to the patient, symptoms of an ailment, information related to previous medical related events (e.g., the patient may provide a scanned copy or a summary of a previous report or test result generated by a health service provider), data obtained by a monitoring sensor or device (e.g., temperature recording, pulse recording, physical constants recording, etc.), any other information that may be provided by the patient, or any combination of the preceding). Furthermore, in such an example, the clinical packet may be communicated by the patient using a communication device 50. An example of a clinical packet is discussed further below with regard to FIG. 2A.

The clinical packet may be communicated by the user via clinical packet transmission 80. Clinical packet transmission 80 may represent any type of transmission that includes one or more clinical packets. Furthermore, clinical packet transmission 80 may be communicated by any communication device 50 over any type of communication channel. For example, clinical packet transmission 80 may occur by e-mail, voicemail, video, fax, cloud services, SMS, MMS, twitter, a social network and/or messaging system, Bluetooth, near field communications interface, communication via an App, any other communication channel, or any combination of the preceding.

Based on the clinical packets received via clinical packet transmissions 80 from communication devices 50, management device 14 may generate one or more reports 38 for one or more patients. A report 38 may represent a report associated with the health of the patient. Furthermore, reports 38 for a particular patient may make up the medical information for that particular patient. An example of a report 38 is discussed further below with regard to FIG. 2B.

Once medical information (e.g., a compilation of reports 38) is generated for a particular patient, a requestor (e.g., the patient, a health service provider, or any other user) may desire to access the medical information for the patient. As such, the requestor may utilize user device 54 to provide a request 84 to management device 14. Request 84 may represent any type of request to access medical information for one or more patients. As an example, if the requestor is the patient, the requestor may provide a request 84 in order to access his own medical information. As another example, if the requestor is a health service provider, the requestor may provide request 84 in order to access medical information for a patient. In such an example, this request 84 may be made so that the health service provider can learn more about the patient before treating the patient, provide additional notes about the patient, refer the patient to another health service provider (e.g., a specialist), any other reason, or any combination of the preceding. Furthermore, access to a patient's medical information may refer to the ability to view a portion of the patient's medical information, update a portion of the patient's medical information, add information to a portion of the patient's medical information, mark a portion of the patient's medical information for deletion or any other type of amendment (although information may be marked for deletion or any other type of amendment, the marked information may still be accessible in its unmarked form or its marked form) any other type of access, or any combination of the preceding.

Request 84 may be communicated to management device 14 in any manner. For example, request 84 may be communicated using one or more of the communication channels (e.g., e-mail, voicemail, video, fax, cloud services, SMS, MMS, twitter, a social network and/or messaging system, Bluetooth, near field communications interface, communication via an App installed on user device 54, any other communication channel, or any combination of the preceding). As another example, request 84 may be communicated using GUI 58 displayed on user device 54. In such an example, a web page associated with management device 14 may be displayed at GUI 58 on user device 54. The user may utilize this GUI 58 to communicate request 84.

After receiving request 84, management device 14 may determine whether to provide the requestor with access to the requested patient's medical information. In order to do so, management device 14 may utilize permission levels 42 for a patient in order to determine whether one or more permission levels 42 have been given to the requestor. For example, if the requestor is the patient's family doctor (who has permission level 42 of full permission), management device 14 may determine that the patient's family doctor has been given full permission to access the patient's medical information. On the other hand, if the requestor is the patient's dietician (who has only been given a permission level 42 for access to medical information regarding the patient's diet and food-related health), management device 14 may determine that the patient's dietician has been given permission to only access medical information regarding the patient's diet and food-related health. As a further example, if the requestor is an unknown doctor or an unknown user (who has not been given any permission level 42 by the user), management device 14 may determine that the requestor has not been given any permission levels 42. In such an example, management device 14 may deny the request (and/or may ask the requestor if the requestor would like to request a permission level 42 from the user). The determination regarding whether to provide the requestor with access to the requested patient's medical information may be based on an identifier associated with the requestor, a log-in by the requestor (e.g., the requestor providing a username and password to log into a GUI associated with management device 14), a code associated with the requestor, any other manner of identifying the requestor and/or the permission level 42 associated with the requestor, or any combination of the preceding. Additionally, while the determination has been discussed above as occurring after the reception of the request 84, the determination regarding whether to provide the requestor with access to particular medical information may occur before or simultaneously with the reception of request 84. For example, a requestor may first log into a GUI associated with the management device 14 (where the log-in may automatically provide the requestor with one or more levels of access to medical information or with access to one or more patient's medical information), and then the requestor may provide request 84 to management device 14. In such an example, the log-in by the requestor may be a permission level 42 and/or may be associated with a permission level 42.

Based on request 84 and permission levels 42, management device 14 may provide medical information transmission 88 to user device 54. Medical information transmission 88 may represent any transmission that includes a portion (or all) of the medical information associated with a patient. For example, if management device 14 determined that the requestor had full permission, medical information transmission 88 may include all of the patient's medical information. As another example, if management device 14 determined that the requestor only had a classification-specific permission, medical information transmission 88 may only include a portion of the patient's medical information (e.g., the portion associated with the classification-specific permission). In such an example, if the patient is visiting a doctor for a checkup on a broken left leg, the doctor may only have a classification-specific permission for “break”, “leg”, and/or “left leg”. As such, the doctor may only be able to access medical information with a classification of “break”, “leg”, and/or “left leg”. The medical information included in medical information transmission 88 may be displayed in any manner. As an example, the medical information may be displayed on GUI 58. Examples of the display of medical information are discussed further below with regard to FIGS. 3-5 and 7.

Modifications, additions, or omissions may be made to the system 10 without departing from the scope of the disclosure. The components of the system 10 may be integrated or separated. For example, communication device 50 and user device 54 may be integrated into a single device. Moreover, the operations of the system 10 may be performed by more, fewer, or other components. For example, the operations of management device 14 may be performed by any number of devices. As used in this document, “each” refers to each member of a set or each member of a subset of a set.

FIG. 2A illustrates an example of a clinical packet according to one embodiment of the disclosure. Clinical packet 100 may be communicated to management device 14 via clinical packet transmission 80 of FIG. 1. The communicated clinical packet 100 may be used to generate a report 38 (discussed below). Furthermore, the communicated clinical packet 100 may also be stored by management device 14 (even after it has been used to generate a report 38). As illustrated, clinical packet 100 includes content 104, patient identifier 108, and provider identifier 112.

Content 104 may represent data associated with the health of a patient. For example, content 104 may be an EMR provided by a health service provider. In such an example, the content may include any information that may be provided by a health service provider about the patient (e.g., an x-ray, a prescription, a health diagnosis, a recommendation made to the patient, test data, a patient referral, results of a psychiatric exam, notes from an examination of the patient, physical pictures, video recording, etc.). As another example, content 104 may be a PHR provided by the patient. In such an example, the content may include any information that may be provided by the patient about himself (e.g., the patient's family history, a new diet the patient is trying, allergies known to the patient, symptoms of an ailment, information related to previous medical related events (e.g., the patient may provide a scanned copy or a summary of a previous report or test result generated by a health service provider), data obtained by a monitoring sensor or device (e.g., temperature recording, pulse recording, physical constants recording, etc.), any other information that may be provided by the patient, or any combination of the preceding).

Clinical packet 100 may further include a patient identifier 108 that identifies which patient the content 104 is associated with. Patient identifier 108 may represent any data that may identify a particular patient. As an example, patient identifier 108 may include a number (e.g., 1234567), an alphanumeric code (e.g., 123abc456), a name (e.g., Patient A), any other identifier of a patient, or any combination of the preceding. Patient identifier 108 may be a unique identifier of the patient. For example, although management device 14 of FIG. 1 may store medical information for any number of patients (e.g., one hundred million patients), the patient identifier 108 for a particular patient may only identify that particular patient. Furthermore, although patient identifier 108 may be unique for each patient, the same patient identifier 108 may be used for a particular patient at all times. As such, medical information for a particular patient may not be stored under two or more different patient identifiers 108.

Patient identifier 108 may be generated in any manner. As an example, patient identifier 108 may be generated in a manner that may ensure that patient identifier 108 is unique for each patient and also in a manner that can be replicated by any health service provider (e.g., so that the same patient identifier 108 is used for a patient no matter what health service provider the patient visits). In such an example, patient identifier 108 may be generated based on a date of birth of the patient, a birth order of the patient (e.g., the patient is the first-born child of the patient's mother), the gender of the patient, a name of the patient (e.g., first, last, and/or middle names of the patient), contact information for the patient (e.g., phone number, e-mail address, mailing address, etc.), a password selected by the patient, any other information about the patient, or any combination of the preceding. In particular, in such an example, management device 14 of FIG. 1 may receive the date of birth of the patient, the birth order of the patient, the gender of the patient, the first and last name of the patient, an e-mail address of the patient, a phone number of the patient, and a password selected by the patient, and the management device 14 may change this information into patient identifier 108 based on any suitable rule or algorithm. For example, the management device 14 may change the patient's information into a patient identifier 108 that includes an open numeric portion (based on the date of birth of the patient, the birth order of the patient, and/or the gender of the patient) and an open alphanumeric portion (based on the first and last name of the patient). In such an example, if the patient was born Jan. 1, 2020 (e.g., 01012020), was his mother's first child (e.g., 01), was male (e.g., 0), and had the first name “First” and the last name “Last”, the open numeric portion of the patient identifier 108 may be “010120200101” and the open alphanumeric portion may be “First.Last”. These open portions may be viewable by any person who has access to at least a portion of the patient's medical information. Furthermore, in such an example, the management device 14 may also change the patient's information into a patient identifier 108 that includes a closed portion (based on the e-mail address of the patient, the phone number of the patient, and/or the password selected by the patient). In such an example, if the patient's email address was first.last@email.com, his phone number was (111) 111-1111, and his password was “secret”, the closed portion of the patient identifier 108 may be “first.last@email.com1111111111secret”. This closed portion may only be viewable by the patient, and therefore, may provide security to the patient's medical information.

As a result of such a patient identifier 108, the health service provider may only need to receive information (such as the information discussed above) about the patient in order to generate a patient identifier 108 for the patient. Furthermore, because the patient identifier 108 is based on information about the patient, himself (as opposed to an identification system that is unique to each health service provider), any health service provider 108 may generate (or otherwise access) the same patient identifier 108 for the patient.

Although clinical packet 100 is described above as including a patient identifier 108, clinical packet 100 may not always include a patient identifier 108. For example, a clinical packet 100 may be an “orphan” packet that does not include a patient identifier 108. Such an orphan packet may be the result of the patient and/or a health service provider sending the clinical packet 100 without identifying the patient identifier 108 (or without knowing the patient identifier 108). In such an example, management device 14 may parse (described below) the clinical packet 100 in order to determine the unknown patient identifier 108. In particular, the parsing of the clinical packet 100 may extract a name mentioned in content 104, and the name may be compared to names of known patients. If a match occurs, the orphan packet may be identified as belonging to the matched patient.

As is discussed above, a clinical packet (such as clinical packet 100) may be transmitted to management device 14 by a health service provider. In order to transmit the clinical packet 100, the health service provider may determine a patient's patient identifier 108 in any manner. For example, the health service provider may generate the patient identifier 108 (or access management device 14 to generate the patient identifier 108) using information provided by the patient. As another example, the health service provider may retrieve the patient identifier 108 from their records. As a further example, the patient may provide the patient identifier 108 to the health service provider. In such an example, the patient may inform the health service provider that his patient identifier 108 is, for example, 123abc456. However, due to the potential length of a patient identifier 108, the patient identifier 108 may also be converted into a code (e.g., by management device 14 and in any suitable manner) that may be more easily used by the patient, such as a bar code or a Quick Response (QR) code. As such, the code may be included on an identification card that may be provided by the patient to the health service provider (which may scan or otherwise enter the code). Furthermore, the patient identifier 108 may also be associated with one or more biometrics of the patient, such as a fingerprint, retinal scan. voice pattern, blood analysis, Deoxyribonucleic acid (DNA) analysis, and/or any other biometric. As such, the health service provider may scan the patient's biometrics in order to determine the patient identifier 108. Accordingly, the health service provider may include the patient identifier 108 in a clinical packet 100.

Clinical packet 100 may further include a provider identifier 112 that identifies which health service provider the content 104 is associated with. As an example, provider identifier 112 may identify the health servicer provider that created content 104, communicated clinical packet 100 to management device 14, and/or signed off on the information in clinical packet 100. Provider identifier 112 may represent any data that may identify a health service provider. As an example, provider identifier 112 may include a number, an alphanumeric code, a name, or any other data that identifies a health service provider. Furthermore, provider identifier 112 may be generated in the same manner as patient identifier 108. Additionally, although clinical packet 100 is described as including a provider identifier 112, clinical packet 100 may not always include a provider identifier 112. For example, clinical packet 100 may be provided by a health service provider or the patient. When the clinical packet 100 is provided by the health service provider, the clinical packet may include provider identifier 112, as is illustrated in FIG. 2A. However, when the clinical packet 100 is provided by the patient himself, clinical packet 100 may not include a provider identifier 112. Such a lack of the provider identifier 112 in the clinical packet 100 may be the result of a health service provider not being involved in the generation and/or communication of clinical packet 100.

Modifications, additions, or omissions may be made to clinical packet 100 without departing from the scope of the disclosure. For example, although clinical packet 100 is illustrated as including particular information, clinical packet 100 may include more or less information. As an example of this, clinical packet 100 may include information that may identify one or more dates and/or times associated with the clinical packet. For example, clinical packet 100 may include information that may identify the date and time the content 104 was generated and/or the date and time clinical packet 100 was communicated to (and/or received by) management device 14.

FIG. 2B illustrates an example of a report according to one embodiment of the disclosure. Report 38 may be generated and stored by management device 14 of FIG. 1. Furthermore, report 38 may be generated based on clinical packet 100 of FIG. 2A. As is illustrated, report 38 includes report identifier 140, patient identifier 108, provider identifier 112, date/time 144, content 104, classifications 148, and types 152. Patient identifier 108, provider identifier 112, and content 104 of FIG. 2B may be similar to patient identifier 108, provider identifier 112, and content 104 of FIG. 2A. Furthermore, although patient identifier 108, provider identifier 112, and content 104 of FIG. 2B may be similar to patient identifier 108, provider identifier 112, and content 104 of FIG. 2A, patient identifier 108, provider 112, and/or content 104 of FIG. 2B may be stored differently in report 38 than it is stored in clinical packet 100. For example, patient identifier 108 may be stored in segments (a first segment for the open numeric portion, a second segment for the open alphanumeric portion, and a third segment for the closed portion).

Report identifier 140 may represent any data that may identify a particular report. For example, report identifier 140 may include a number, an alphanumeric code, a name, an md5_file( ) code, or any other data that identifies a report 38. By identifying a report 38 using report identifier 140, all of the information (patient identifier 108, provider identifier 112, date/time 144, content 104, classifications 148, types 152) may be associated with the report identifier 140 and the report 38. As such all the information may be stored together and/or in a manner that allows all the information for a report 38 to be retrieved. Furthermore, when the report identifier 140 for a particular report 38 is determined to be part of medical information that may be communicated for display to a requestor, all of the information associated with report identifier 140 and report 38 may be communicated for display also.

Date/time 144 may represent any data that may identify the date and/or time associated with content 104. For example, if content 104 (e.g., an x-ray) is created by a health service provider on Jan. 15, 2014 at 1:15 p.m. CDT, the date/time 144 may be data that identifies that particular date and time. As such, a user may be able to understand when content 104 was generated. Furthermore, date/time 144 may further allow medical information for a patient to be communicated for display as a timeline. Date/time 144 may also be data that identifies any other particular date and time associated with content 104. For example, date/time 144 may identify the date and time clinical packet 100 was communicated to management device 14, the date and time clinical packet 100 was used to generate report 38, the date and time report 38 was approved by the doctor who communicated it (e.g., a doctor may check to see that report 38 was generated correctly), and/or any other date and time. Furthermore, date/time 144 may include more than one date/time. For example, the date/time 144 may be data that identifies multiple dates (e.g., the date and time the content 104 was generated, the date and time clinical packet 100 was communicated to (and/or received by) management device 14, the date and time clinical packet 100 was used to generate report 38, and the date and time report 38 was approved by the doctor who communicated it).

Classification 148 may represent any data that may identify a medical classification of content 104. As an example, classification 148 may include data associated with a diagnosis in content 104. In such an example, if content 104 includes an x-ray of a patient's broken left leg, classification 148 may include data associated with that x-ray, such as “personal episode”, “leg”, “left leg”, “broken left leg”, “broken tibia of left leg”, any other suitable classification of the x-ray, or any combination of the preceding. Classification 148 may include one or more grouping classifications which may provide an indication of the importance of the content 104 and/or the reason the content 104 was generated. Grouping classifications may include “check/routine”, “isolated symptom”, “drug related data”, “personal episode” (or “personal health event”), any other grouping classification, or any combination of the preceding. The “check/routine” grouping classification may represent a diagnosis in content 104 associated with a standard/routine medical check (e.g., annual physical of a patient, blood pressure test, glucose test, etc.). The “isolated symptom” grouping classification may represent a diagnosis in content 104 associated with an incident that the patient is not overly concerned about (e.g., a new diet the patient is trying, a slight fever reported by the patient without going to a doctor, a new workout regime, etc.). The “drug related data” grouping classification may represent a diagnosis in content 104 associated with prescriptions, medications, and/or drugs that are being prescribed to the patient and/or that are currently being taken by the patient (e.g., blood pressure medication, acne medication, etc.). The “personal episode” grouping classification (or the “personal health event” grouping classification) may represent a diagnosis in content 104 associated with an important incident (e.g., a broken leg, chronic knee problems, severe headaches, dehydration, etc.).

Classification 148 may also include (or may alternatively include) one or more descriptive classifications which may provide a description of the diagnosis and/or the content 104. Examples of descriptive classifications may include “leg”, “left leg”, “broken left leg”, “broken tibia of left leg”, “headache”, “migraine”, “cavity”, “dislocation”, any other description of a diagnosis and/or the content 104, or any combination of the preceding. Descriptive classifications may be a subset of grouping classifications. For example, when a patient breaks his leg, the grouping classification may be “personal episode” and the descriptive classifications of “leg”, “left leg”, “broken left leg” may be subsets of the “personal episode”.

Classification 148 may assist a health service provider and/or a patient in understanding what is in content 104 of report 38. For example, the health service provider and/or the patient may be able to look at the classification 148 in order to determine that the patient had an important incident where he broke his left leg (as opposed to reviewing the content 104, itself). As such, if a health service provider is looking for any reports 38 associated with a patient's diabetes, the health service provider may be able to skip over reports 38 that include a classification 148 of “broken left leg”. Classification 148 may also allow health service provider and/or patient to filter and/or search for a particular report 38 (e.g., when the health service provider and/or patient only wants to view reports 38 associated with the patient's “left leg” or “broken left leg”). Classification 148 may also be related to permission levels 42 of FIG. 1, such as classification-specific permission. As an example, if a patient is going to visit a health service provider to have a check up on their healing broken left leg, the patient may give the health service provider a classification-based permission that grants the health service provider access to only reports 38 that include classifications 148 for “leg”, “left leg”, “broken left leg”, “break”, or any combination of the preceding. As such, the health service provide may only be able to access reports 38 that include one or more of these classifications. Furthermore, each report 38 may include any number of classifications 148. For example, an x-ray of a patient's broken left leg may include three classifications 148, such as “personal episode”, “leg”, and “broken left leg”.

Classification 148 may be determined by management device 14. Furthermore, classification 148 may be determined in any suitable manner. For example, classification 148 may be determined by management device 14 based on content 104. An example of such a determination is disclosed below.

First, management device 14 may generate data associated with content 104 by converting content 104 into machine-encoded text. For example, management device 14 may utilize optical character recognition (OCR) in order scan content 104 and convert the scanned content into machine-encoded text. In such an example, OCR technology may be utilized to convert an x-ray (which may include one or more identifiers, such as “left leg”, “Jan. 15, 2015” “Doctor B”, “Patient A”) into text (e.g., “left leg Jan. 15, 2015 Doctor B Patient A”) as data associated with content 104. Management device 14 may utilize any type of OCR program for converting content 104 into machine-encoded text, such as OMNIPAGE Standard, PRESTO! OCR, Readiris Pro, ABBYY PDF TRANSFORMER, Tesseract, or any other OCR program.

Second, once this data associated with content 104 is generated, management device 114 may parse the data. Parsing may represent a process of analyzing a string of symbols according to rules of formal grammar, as well as image matching or raw image comparison and analysis. As an example, management device 14 may parse the data associated with the content 104 (e.g., “left leg Jan. 15, 2015 Doctor B Patient A”) in order to determine that content 104 is associated with “left leg”, “Jan. 15, 2015”, “Doctor B”, and “Patient A” Management device 14 may utilize any type of parsing program to parse the data, such as ANTLR, Bison, Coco/R, GOLD, or any other parsing program.

Third, based on this parsing, management device 14 may determine one or more classifications 148 for the content. As an example, management device 14 may determine the classifications 148 (and types 152, as is discussed below) by making inferences based on the parsed data. In such an example, management device 14 may determine that the content is a “personal episode” based on the fact that the patient was treated by “Doctor B” for the incident (e.g., the fact that the patient went to a doctor for treatment infers that the incident was important). Furthermore, management device 14 may determine that the content is a “check/routine” based on comparing the parsed term “physical” in the content to terms that are attributable to standard/routine checks, may determine that the content is an “isolated symptom” based on the fact that the clinical packet 100 was sent by the patient and did not include a provider identifier 112 or the name of a doctor in the parsed data, and/or may determine that the content is “drug related data” based on the fact that the parsed data includes the term “prescription” and the name of a particular type of drug (e.g., blood pressure medication).

As another example, management device 14 may determine the classifications 148 by matching current classifications 148 to the parsed data. In such an example, management device 14 may match the parsed data of “left leg” to one or more current classifications 148 of “leg” and “left leg”. Based on such a match, management device 14 may determine these classifications 148 and associate them with content 104 and report 38. As a further example, management device 14 may generate new classifications 148 based on the parsed data. For example, if the parsed data of “left leg” does not match any current classifications 148, management device 14 may generate a new classification 148, such as “left leg” and/or “leg”. As such, management device 14 may determine one or more classifications 148 for content 104.

Furthermore, in addition to management device 14 using parsing to determine one or more classifications 148 for the content 104 (and one or more types 152 for the content 104, as is discussed below) the parsing may also allow one or more portions of the content 104 to be translated. As an example, the parsing of content 104 may result in particular terms being found in content 104, such as the medical term “type II uncontrolled diabetes”. These terms may be matched to a database of terms and/or identifiers, such as the International Classification of Diseases (ICD). For example, the medical term “type II uncontrolled diabetes” may be matched to the ICD code 250.02. Additionally, this code may be matched to a database of foreign language translations of the code (e.g., a thesaurus) to provide a translation of the medical term. As such, if a Spanish-speaking health service provider accesses the report 38, the Spanish-speaking health service provider may understand that the patient has been diagnosed with type II uncontrolled diabetes even though that diagnosis was in content 104 written in the English language.

Type 152 may represent any data that may identify a type of content 104. For example, type 152 may be a medical identifier of the content 104. In such an example, if the content 104 is an x-ray, the type 152 of the content 104 may be “x-ray”. Furthermore, if the content 104 is a physician's notes, the type may be “physician notes”. Additionally, if the content 104 if a blood test, the type may be “blood test”. Examples of type 152 may further include: “imaging test”, “lab test”, “urine test”, “genetic profile”, “echography Ob/Gyn”, “echography abdominal”, “echocardiography”, “magnetic resonance imaging” (MRI), “positron emission tomography”, “emergency report”, “outpatient visit report”, “discharge report”, “continuity report”, “medical certificate”, any other medical identifier of the content 104, or any combination of the preceding. Furthermore, because types 152 may represent any data that may identify a type of content 104, types 152 may be referred to as content types.

Similar to classifications 148, types 152 may assist a health service provider and/or a patient in understanding what is in content 104 of report 38. Furthermore, types 152 may also allow health service provider and/or patient to filter and/or search for a particular report 38. Additionally, each report 38 may include any number of types 152.

Type 152 may be determined by management device 14. Furthermore, type 152 may be determined in any suitable manner. For example, type 152 may be determined by management device 14 based on content 104. In such an example, type 152 may be determined in a manner similar to classification 148. Furthermore, in such an example, type 152 may also be determined (or may be alternatively determined) based on image matching or raw image comparison and analysis. For example, images included in content 104 (e.g., MRI scans, x-rays, prescriptions) may be compared to known images. In such an example, if the images in content 104 match the known images (e.g., the MRI scan matches a known image of an MRI scan), the type 152 may be determined to be the same as the matched image (e.g., MRI).

Although classifications 148 and types 152 have been described above as being determined automatically by management device 14, classifications 148 and types 152 may also be input by a user. For example, a health service provider may further be able to add and/or change classifications 148 and/or types 152. In such an example, a health service provider may transmit a clinical packet 100 including content 104 that is an x-ray of the patient's left leg. If the health service provider later accesses that report 38, and sees that the report 38 includes a classification 148 of only “left leg”, the health service provider may add a classification 148 of “break” and/or “broken left leg”. As another example, if the health service provider sees that the classification 148 includes “leg”, the health service provider may reclassify classification 148 to be “left leg”. As a further example, the health service provider may add the classification 148 and/or type 152 prior to the generation of the report 38. In such an example, the health service provider may include the classification 148 with the clinical packet 100 before it is sent to management device 14 or may add the classification 148 to the clinical packet 100 after it is received by management device 14 but before the clinical packet 100 is parsed to generate report 38.

Modifications, additions, or omissions may be made to report 38 without departing from the scope of the disclosure. For example, although report 38 has been described above as being generated based on a clinical packet (e.g., clinical packet 100 of FIG. 2A), report 38 may be generated based on more than one clinical packet, such as two clinical packets, three clinical packets, or any other number of clinical packets (e.g., report 38 may be generated based on two or more different clinical packets all including a particular classification 148, such as “broken left leg”), or report 38 may be generated based on only a portion of a clinical packet (e.g., a single clinical packet associated with both a physical exam and also the prescription of a medication during the same visit with a health service provider may be used to generate two or more reports 38). As another example, although report 38 has been described as including particular information, report 38 may include more, less, or different information. As an example of this, report 38 may include one or more of the following information in addition to (or as an alternative to) one or more of report identifier 140, patient identifier 108, provider identifier 112, date/time 144, content 104, classifications 148, and types 152 of report 38:
Id—an internal identifier used to handle the relationship between various tables that store information regarding patients, classifications 148, and types 152
IdUsu—an identifier of the patient, such as patient identifier 108
IdPin—an identifier of clinical packet 100
NumImages—the number of images in content 104
RawImage—the name of the first image file in content 104
RawImage2—the name of the second image file in content 104
RawImage3—the name of the third image file in content 104
Fecha—the date and/or time when report 38 was generated (using clinical packet 100) and/or stored
FechaInput—the date and/or time when content 104 was created by a health service provider or anther user
EvRuPunt—a flag associated with the grouping classifications (e.g., 0=“personal episode”, 1=“check/routine”, 2=“isolated symptom”, 3=“drug related data”). One or more of the flags may have pointers to other classifications 148, such as descriptive classifications such as “leg”
Evento—a pointer to other classifications 148. For example, a “personal episode” may have a pointer to descriptive classifications such as “leg”, “left leg”, “broken left leg”
Tipo—a pointer to types 152 of report 38
Especialidad—a pointer to a medical specialty associated with report 38 and/or content 104 (e.g., surgery, neurology)
EspecialidadT—a second pointer to a medical specialty associated with report 38 and/or content 104 (e.g., surgery, neurology)
ICD—an ICD code associated with report 38 and/or content 104
TextoRel—raw OCR'd text from content 104 (prior to parsing)
confirmcode—a cryptographic hash code (e.g., 128 bit) used to isolate and identify every report 38 and/or clinical packet 100 until confirmed by the patient and/or the health service provider
approved—a flag associated with the approval of the report 38 and/or clinical packet 100 (e.g., the flag is set to 1 if the report 38 and/or clinical packet 100 is verified and confirmed by the patient and/or the health service provider)
CENTRO—the hospital or other health service provider that produced the clinical packet 100 (if any)
EMAILORIGEN—the e-mail used to communicate the clinical packet 100 (if any)
CANAL—the channel used to communicate the clinical packet 100
NeedACTION—a flag used to identify whether report 38 needs a further action
IdEmail—an identifier associated with the e-mail used to communicate the clinical packet 100 (if any)
FechaEmail—the date and/or time that the e-mail with the clinical packet 100 was sent and/or delivered (if any)
IdUsFIXED—the open numeric portion of the patient identifier 108
IdUsFIXEDNAME—the open alphanumeric portion of the patient identifier 108
IdUsRESERV—the closed portion of the patient identifier 108 (reserved for the patient)
IdMEDEmail—the e-mail of the health service provider associated with content 104 (if any)
IdMedRESERV—a reserved code (e.g., specific word) for the health service provider associated with content 104 (if available)
SignedUSER—identifier of the user (e.g., patient, health service provider) that verified and confirmed the report 38 and/or clinical packet 100 (if any)
IdMed—identifier of the health service provider associated with the content 104 (if any)
CreatorType—an identifier associated with the type of the creator of content 104 and/or clinical packet 100 (e.g., a flag set to 1 if the creator is a health service provider, or set to NULL if the creator is a patient)
IdCreator—a pointer to the identity of the creator
SignedUSERDate—the date and/or time that the user verified and confirmed the report 38 and/or clinical packet 100 (if any)
ValidationStatus—a flag to a type of validation (e.g., 1=Cancelled; 0=VALID; 1=Not a Valid patient identifier 108; 2=health service provider not Present; 3=awaiting user id; 4=Waiting for user confirmation; 8=Content Secured; 99=Not Parsed)
NextAction—a flag to indicate the next suggested action (e.g., 1: Confirm with health service provider, 2: Confirm with Patient. NULL: no specific action suggested)
Location—a flag to indicate what server, computing device, and/or management device 14 first received the clinical packet 100

FIG. 3 illustrates an example of a graphical user interface according to one embodiment of the disclosure. Graphical user interface 200 may be an example of a graphical user interface communicated for display on graphical user interface 58 of user device 54 of FIG. 1. As illustrated, graphical user interface 200 includes communication channel usage 204 and list of reports 208.

Communication channel usage 204 may represent the usage by the health service provider of particular communication channels in order to transmit clinical packets 100 to management device 14 via clinical packet transmission 80. As illustrated, communication channel usage 204 may identify particular channels utilized by the health service provider (e.g., phone, text, e-mail, fax, mobile app, web) and may further identify how many times those particular communication channels have been utilized. For example, communication channel usage 204 may identify that the e-mail communication channel has been used for 30 of 58 clinical packets 100 and may further identify that the text communication channel has been used for 10 of 58 clinical packets 100. Communication channel usage 204 may identify any number of communication channels. Furthermore, communication channel usage 204 may identify how many times those particular communication channels have been utilized in any manner. For example, communication channel usage 204 may provide a number of uses of a communication channel (e.g., the e-mail communication channel was used for 30 of 58 clinical packets 100), a percentage of the number of uses of a communication channel (e.g., the e-mail communication channel has been used for 51.7% of the clinical packets 100), a symbol of the number of uses of the communication channel (e.g., a symbol, such as a circle, that enlarges as the communications channel is used more), any other manner of identifying how many times a communication channel has been utilized, or any combination of the preceding.

List of reports 208 may represent a list of reports for the health service provider. For example, list of reports 208 may include reports 38 generated based on clinical packets 100 communicated by the health service provider, reports 38 transmitted to the health service provider as a referral, any other report 38, or any combination of the preceding. List of reports 208 may allow the health service provider to click on (or otherwise select) and view each report 38 in order to understand what reports 38 the health service provider may be responsible for. As an example, list of reports 208 may allow a health service provider to add and/or change a classification 148 for a particular report 38.

Modifications, additions, or omissions may be made to graphical user interface 200 without departing from the scope of the disclosure. For example, although graphical user interface 200 has been described as including particular information, graphical user interface 200 may include more or less information.

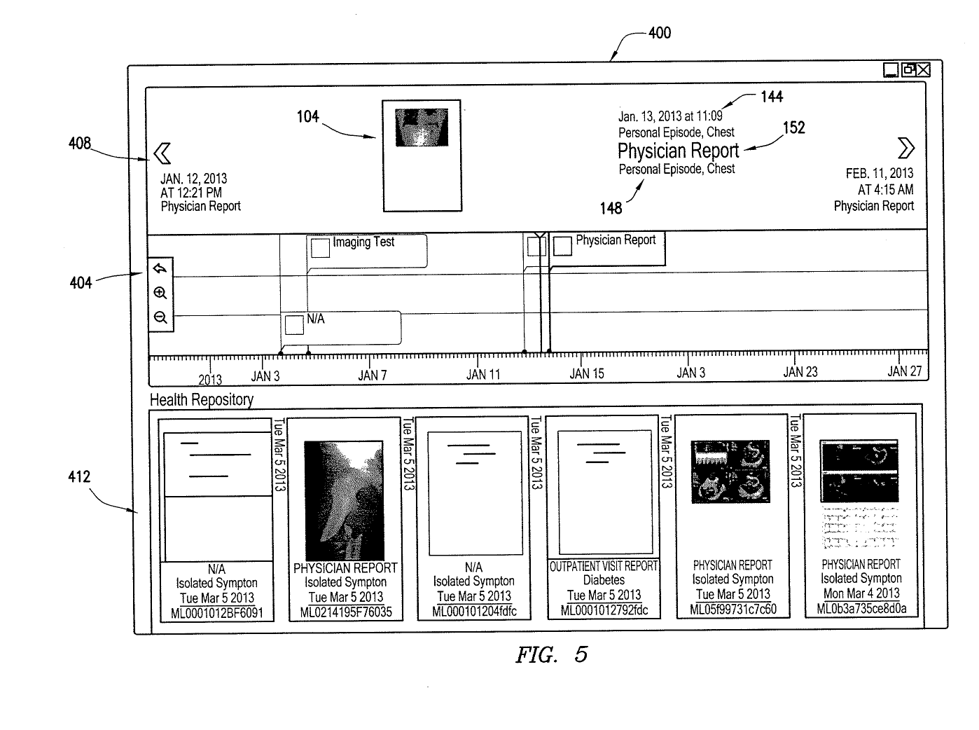

FIG. 4 illustrates another example of a graphical user interface according to one embodiment of the disclosure. Graphical user interface 300 may be another example of a graphical user interface communicated for display on graphical user interface 58 of user device 54 of FIG. 1. As illustrated, graphical user interface 300 includes list of patients 304.

List of patients 304 may represent a list of patients of the health service provider. For example, list of patients 304 may include patients that have been treated by the health service provider, that are scheduled to be treated by the health service provider, that may have been referred to the health service provider, any other patient, or any combination of the preceding. The health service provider may utilize list of patients 304 in order to select a particular patient and view medical information associated with that particular patient. For example, by clicking on (or otherwise selecting) a particular patient in list of patients 304, health service provider may provide request 84 of FIG. 1 to management device 14. Based on this request 84, management device 14 may determine whether the health service provider has one or more permission levels 42 associated with the patient. If so, management device 14 may provide at least a portion of the medical information to the health service provider. On the other hand, if the health service provider does not have a permission level 42 associated with the patient (e.g., when the patient has been referred to the health service provider but the patient has yet to provide any permission levels 42 to the health service provider), management device 14 may deny the request 84 by the health service provider. Additionally, management device 14 may also provide health service provider an opportunity to request a permission level 42 from the particular patient. If the health service provider requests a permission level 42, management device 14 may correspond with the patient (e.g., by e-mail, voicemail, etc.) in order to attempt to receive the permission level 42 for the health service provider. When the patient does grant the permission level 42 (or decides not to grant the permission level 42), management device 14 may provide the appropriate response to the health service provider (e.g., providing the health service provider with access to the medical information of the patient, or informing the health service provider that the permission level request was denied).

Modifications, additions, or omissions may be made to graphical user interface 300 without departing from the scope of the disclosure. For example, although graphical user interface 300 has been described as including particular information, graphical user interface 300 may include more or less information.

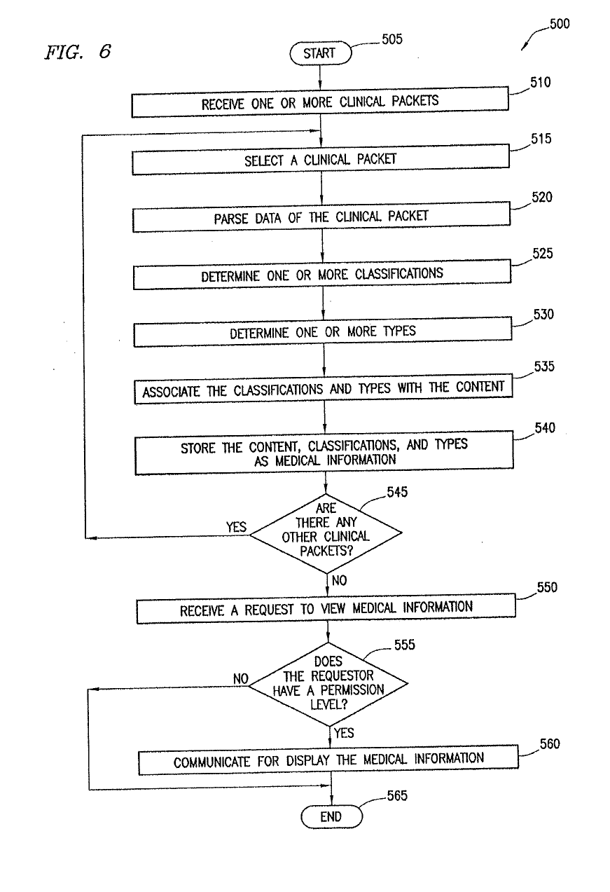

FIG. 5 illustrates another example of a graphical user interface according to one embodiment of the disclosure. Graphical user interface 400 may be another example of a graphical user interface communicated for display on graphical user interface 58 of user device 54 of FIG. 1. As illustrated, graphical user interface 400 includes timeline 404, current report data 408, and repository health data 412.

Timeline 404 represents an illustration of a timeline of medical information for the patient. For example, timeline 404 may provide each report 38 for the patient in timeline-order based on the date/time of report 38. As such, a health service provider may be able to scroll through the patient's timeline 404 and view how the patient's health has progressed from the beginning of the timeline 404 to the end. Timeline 404 may include an indicator for each report 38 associated with the patient. For example, if the patient has a report 38 associated with Jan. 3, 2014 and a report 38 associated with Jan. 12, 2014, timeline 404 may include indicators for each of those reports 38. As such, the health service provider may be able to scroll through the timeline 404 and select particular reports 38 for further view. Although timeline 404 is illustrated as including all of the reports 38 for a particular patient, if the health service provider does not have a permission level 42 for particular reports 38, those reports 38 may not be displayed on timeline 404 (or those reports 38 may be displayed on timeline 404 as “blinded reports,” thereby allowing the health service provider to request permission from the patient to access those reports 38).

Current report data 408 may represent an illustration of one or more pieces of information included in a report 38 selected by the health service provider in timeline 404. For example, as illustrated, current report 408 includes content 104, date/time 144, classifications 148 (e.g., “personal episode”, “chest”), and type 152 (e.g., “physician report”). Current report data 408 may efficiently summarize the information of report 38 and may further provide content 104 for view by the health service provider. When content 104 is clicked on (or otherwise selected), an enlarged view of content 104 may be displayed (not shown). The enlarged view of content 104 may allow the health service provider to view content 104 in detail, and may further allow the health service provider to zoom in (or zoom out) on particular portions of content 104. Furthermore, if content 104 is multiple pages, the enlarged view may allow the health service provider to view each of the pages.

Repository health data 412 may represent a list of reports 38 for view by the health service provider. Repository health data 412 may illustrate reports 38 in a different order than timeline 404. For example, while timeline 404 may list each report 38 in timeline-order based on the date/time, health repository 412 may list reports 38 (e.g., by providing images of reports 38) in any other order (e.g., order of importance, order of frequency of viewing, etc.). This may allow the health service provider to understand medical information associated with the patient without scrolling through the timeline 404. Each of the reports 38 in repository health data 412 may be clicked on (or otherwise selected) in order to display an enlarged view of content 104 and one or more of the other items in report 38 (e.g., classifications 148, types 152, etc.). Repository health data 412 may further include “blinded reports” that the health service provider does not have permission to access. These “blinded reports” may be clicked on (or otherwise selected) in order for the health service provider to request permission from the patient to access the blinded reports.

Modifications, additions, or omissions may be made to graphical user interface 400 without departing from the scope of the disclosure. For example, although graphical user interface 400 has been described as including particular information, graphical user interface 400 may include more or less information. For example, graphical user interface 400 may include any other information regarding the patient. In such an example, graphical user interface 400 may include demographic information for the patient (e.g., date of birth, gender, biometric data (e.g., height, weight, etc.), prescription-based data (e.g., what prescriptions the patient is currently on or previously on, etc.), allergy data (e.g., what the patient is allergic to, etc.), any other data regarding the patient, or any combination of the preceding).

FIG. 6 illustrates a method for management of medical information according to one embodiment of the disclosure. One or more steps of method 500 may be performed by management device 14. For example, one or more steps of method 500 may be performed in accordance with the description of one or more of FIGS. 1-5 and 7-8.

The method 500 begins at step 505. At step 510, one or more clinical packets are received. The clinical packet may be received from one or more communication devices 50 of FIG. 1 over one or more communication channels (e.g., e-mail, voicemail, video, fax, cloud services, SMS, MMS, etc.). Furthermore, the clinical packet may be received from any type of user (e.g., a patient, a health service provider, any other type of user) of communication device 50. The clinical packet may be clinical packet 100 of FIG. 2A. As such, the clinical packet may include content 104, patient identifier 108, and/or provider identifier 112. Any number of clinical packets may be received at step 510, and the clinical packets received at step 510 may be associated with any number of patients.

At step 515, a clinical packet is selected. Any of the clinical packets may be selected, and the clinical packets may be selected in any suitable manner. Once the clinical packet is selected at step 515, one or more steps of method 500 (such as steps 520-540 of method 500) may be performed for that particular selected clinical packet.

At step 520, data of the clinical packet is parsed. For example, the content (such as content 104) in the clinical packet may be converted into text, and the text may be parsed in order to analyze the text. In such an example, an x-ray may be OCR'd and parsed in order to determine the text “left leg”.

At step 525, one or more classifications may be determined. The classification may be classification 148 of FIG. 2B. The classification may be determined for the content included in the clinical packet. For example, based on the parsing of an x-ray of a broken leg, the classification “personal episode”, “leg”, “left leg”, and/or “broken left leg” may be determined.

At step 530, one or more types are determined. The type may be type 152 of FIG. 2B, and may be referred to as a content type. The type may be determined for the content included in the clinical packet. For example, based on the parsing of an x-ray of a broken leg, the type “x-ray” may be determined.

At step 535, the classifications and types are associated with the content. For example, the classifications and types may be associated with the content included in a report identifier (such as report identifier 140 of FIG. 2B). As such, the classifications, types, and content may be associated with a particular report 38.

At step 540, the content, classifications, and types are stored as medical information. For example, the content, classifications, and types (which may be associated with a particular report 38) may be stored as medical information for the patient to which the report 38 belongs. Such medical information may include each report 38 generated by management device 14 for that patient. As such, medical information may be generated for the patient.

At step 545, it is determined whether there are any other clinical packets for which classification and types have not been determined. If there are additional clinical packets, method 500 may move back to step 515 where a clinical packet is selected. As such, steps 515-540 of method 500 may be repeated for each clinical packet. On the other hand, if there are not any other clinical packets, the method 500 may move to step 550.

At step 550, a request to view medical information is received. The request to view medical information may include a request to view medical information for a particular patient, and may be received from any requestor (e.g., the patient, a health service provider, any other type of requestor). The request to view medical information may be received from a user device 54 of FIG. 1. Furthermore, the request may be transmitted to management device 14 using graphical user interface 58 of user device 54 (or using any other communication channel). As an example, the request may be transmitted by the health service provider selecting a particular patient in a graphical user interface, such as graphical user interface 300 of FIG. 4.

At step 555, it is determined whether the requestor has a permission level for the patient. The permission level may be a permission level 42 of FIG. 1. If the requestor does not have a permission level for the patient (or, for example, the requestor has a permission level of no permission), the method may move to step 565, where method 500 ends. On the other hand, if the requestor does have a permission level (or, for example, has a permission level other than no permission) for the patient, the method may move to step 560.

At step 560, medical information is communicated for display. The medical information communicated for display may include any portion of the medical information for a patient. For example, the portions of the medical information that are communicated for display may be based on the permission levels that have been given to the health service provider. In such an example, if the health service provider has been given full permission, all of the medical information of the patient may be communicated for display to the health service provider. On the other hand, if the health service provider has only been given a classification-specific permission, only reports 38 that include a classification (such as classification 148) that matches the classification-specific permission may be communicated for display to the health service provider.

The medical information may be communicated to the requestor as any type of display. As an example, the medical information may be communicated for display as a timeline, such as is illustrated in graphical user interface 400 of FIG. 5. Once the medical information has been communicated for display, the method may move to step 565, where the method ends.

The steps illustrated in FIG. 6 may be combined, modified, or deleted where appropriate. Additionally, the described steps may be performed in any order. For example, a request for medical information may be received before a classification and type has been determined for every clinical packet. As another example, a request for medical information may be received after or simultaneously with the determination regarding whether the requestor has a permission level for a particular patient. In such an example, the requestor may log-in to a GUI associated with the management device, and such a log-in may automatically provide the requestor with one or more levels of access to medical information or with access to one or more patient's medical information. The requestor may then request access to particular medical information. Furthermore, additional steps may also be added to the example operation. As a first example, if the requester does not have a permission level at step 555, method 500 may not end. In such an example, the method may further include steps where a request to receive a particular permission level from a patient is received (e.g., the requestor clicks on (or otherwise selects) a “blinded report”). Following such a request, management device 14 may correspond with the patient (e.g., by e-mail, voicemail, etc.) to ask whether the patient will give the requested permission level. Based on this, management device 14 may determine whether the patient has given the requested permission level. If the patient has given the requestor the particular permission level, management device 14 may communicate for display the medical information to the requestor. As a second example, if a clinical packet is received at step 510 from a health service provider, the method may further include steps where the patient is informed of the clinical packet. In such an example, management device 14 may determine (based on the clinical packet) the patient identifier 108 included in the clinical packet, and may send a confirmation (e.g., by e-mail, voicemail, etc.) of the clinical packet to the patient associated with the patient identifier 108.

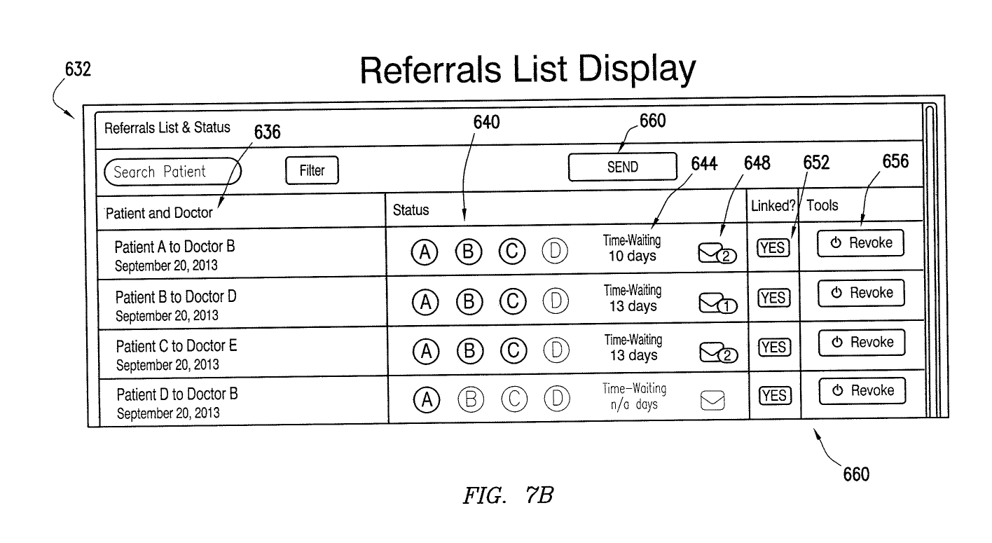

FIGS. 7A-7B illustrate an example of a graphical user interface according to one embodiment of the disclosure. Graphical user interface 600 may be an example of a graphical user interface communicated for display on a graphical user interface 58 of user device 54 of FIG. 1.

According to the illustrated embodiment, graphical user interface 600 may allow a health service provider (e.g., a doctor) to manage information associated with referrals of patients to other health service providers (e.g., other doctors, hospitals, etc.). Traditionally, when a doctor refers a patient to another doctor, the doctor may typically attempt to keep track of the referral by saving communications associated with the referral (e.g., referral e-mails), keeping a logbook (or other documentation) of referrals, and/or keeping track of communications sent back to the doctor about the referral (e.g., letters that explain the diagnosis made by the doctor). Unfortunately, such traditional methods may be deficient. For example, if the doctor is not diligent about keeping records, the doctor may be unable to fully track a referral. Furthermore, if the referred doctor or the patient does not check back in with the initial doctor, the initial doctor may not have any access to information regarding the status of the referral (e.g., whether the patient ever visited the referred doctor), the result of the referral (e.g., a diagnosis resulting from the referral), or any other information associated with the referral. Finally, even if the doctor is able to keep track of all of the information associated with referrals, reviewing such information may require significant amounts of time.

One or more of these deficiencies, however, may be addressed by system 10 of FIG. 1 and/or graphical user interface 600. As illustrated, graphical user interface 600 includes image 604, current summary report 624, selected summary report 628, and referral list 632.

Image 604 may represent an illustration of information regarding a status associated with a patient. For example, image 604 may illustrate patient status information associated with the referral of patients from a first health service provider to one or more second health service providers. A referral by a first health service provider to a second health service provider may refer to any manner of a first health service provider directing (or otherwise suggesting) that the patient seek help or information from a second health service provider. Furthermore, the referral may be from any type of first health service provider to any type of second health service provider. As an example, the first health service provider may be a doctor (or any other health service provider) and the second health service provider may be another doctor (or any other health service provider). The first health service provider may be associated with a patient. For example, the first health service provider may be the doctor of the patient, a hospital utilized by the patient, any other health service provider that has provided a health-related service to the patient, or any combination of the preceding. The second health service provider may also be associated with a patient. For example, the first health service provider may have referred the patient to the second health service provider.

Image 604 may have any size and/or shape, and may illustrate information in any manner. For example, image 604 may be a pie chart, a bar chart, a line chart, an irregular pie chart (e.g., a pie chart with a non-circular circumference, such as a square, octagon, or any other type of polygon), any other type of image that may illustrate information, or any combination of the preceding.

As illustrated, image 604 includes sections 608, status indications 612, groupings 616, and assemblies 620. Section 608 may be a portion of image 604 that may represent a patient. For example, section 608a may represent a patient (e.g., patient A) that was referred by a first health service provider (e.g., doctor A) to a second health service provider (e.g., doctor B). Section 608 may have any size and/or shape. For example, section 608 may be a sector, a polygon, a bar, any other shape, or any combination of the preceding. Furthermore, the size of a section 608 may be based on the number of sections 608 included in image 604. As an example, when image 604 includes 16 sections 608 (e.g., a section 608 for each of the 16 referred patients), the section 608 may have a size that is 1/16th of image 604.

Status indication 612 may be a portion of image 604 that may represent a status associated with a patient. A status associated with a patient may refer to any type of status. For example, when a patient (e.g., patient A) is referred to a second health service provider (e.g., doctor B), a status associated with the patient may be that the patient has received a diagnosis from the second health service provider. Furthermore, the status associated with a patient may include one or more stages. For example, the status associated with a patient may include an acknowledgment status (e.g., where the second health service provider has acknowledged to the first health service provider that they are willing to see the patient), an appointment status (e.g., where the patient has scheduled an appointment with the second health service provider), an information reviewed status (e.g., where the second health service provider has reviewed one or more pieces of information, such as reports 38, provided to the second health service provider by the first health service provider), an appointment completed status (e.g., where the patient completed an appointment with the second health service provider and/or where the second health service provider has provided a diagnosis (or other information) to the patient as a result of an appointment), any other status, or any combination of the preceding. The status associated with a patient may change. For example, after the patient has schedule an appointment with the second health service provider, the status associated with the patient may change from an acknowledgment status to an appointment status.

Status indication 612 may be illustrated in section 608. For example, status indication 612 may be illustrated in image 604 as occupying at least a portion of a section 608. As such, by viewing section 608 in image 604, a user (e.g., a user of user device 54) may be able to also view status indication 612. Status indication 612 may be any type of illustration of a status associated with a patient. For example, status indication 612 may be illustrated as a colored shape that fills up one or more portions of section 608 based on a stage of the status of the patient, a number (e.g., 1, 2, 3, 4), an alphanumeric character (e.g., A, B, C, D), any other indication, or any combination of the preceding. In an example where status indication 612 is a colored shape that fills up one or more portions of section 608 based on a stage of the status of the patient, status indication 612 may fill in none, a portion, or all of section 608. Furthermore, the amount of area of section 608 that status indication 612 may fill in may correlate to the status associated with the patient. As an example, if the patient has a first stage status (e.g., acknowledgement status), a first portion of section 608 may be filled in, as is seen with regard to status indication 612a of section 608a. Furthermore, if the patient has a second stage status (e.g., appointment status), a second portion of section 608 may be filled in, as is seen with regard to status indication 612b of section 608b. If the patient has a third stage status (e.g., information reviewed status), a third portion of section 608 may be filled in, as is seen with regard to status indication 612c of section 608c. If the patient has completed all of the stages of a status indication (e.g., appointment completed status), the status indication 612 may fill up the entire area of section 608.

Grouping 616 may be a portion of image 604 that may represent a second health service provider. For example, grouping 616 may represent a second health service provider that a patient was referred to (e.g., grouping 616a may represent doctor B that patient A was referred to by doctor A). Grouping 616 may include one or more sections 608 in image 604. For example, if doctor A has referred four patients to doctor B, grouping 616 may include four sections 608 of image 604, as is illustrated by grouping 616a (which includes sections 608a, 608b, 608c, and 608d). The number of sections 608 included in grouping 616 may be based on the number of patients referred to the second health service provider represented by grouping 616. For example, if only one patient is referred to the second health service provider, grouping 616 may only include one section 608, as is seen in grouping 616b. As another example, if 10 patients are referred to the second health service provider, grouping 616 may include 10 sections 608. Grouping 616 may include any size and/or shape. As an example, grouping 616 may include the size and/or shape of all of the sections 608 included in the grouping 616 (e.g., grouping 616 may have the size and/or shape of four sections 608 when four sections 608 are included in grouping 616). Furthermore, according to the illustrated embodiment, grouping 616 may be an arc of one or more of the sections 608.

Assembly 620 may be a portion of image 604 that may represent a third health service provider. For example, assembly 620 may represent a third health service provider (e.g., hospital A) that is associated with one or more second health service providers (e.g., doctors B, C, and D may work at hospital A). Additionally, the third health service provider may further be associated with a patient (e.g., when patient A is referred to doctor B, patient A may now also be associated with hospital A). Assembly 620 may include one or more groupings 616 in image 604. For example, if three doctors are associated with a hospital represented by assembly 620, assembly 620 may include three groupings 616 of image 604, as is illustrated by assembly 620 (which includes groupings 616a, 616b, and 616b). The number of groupings 616 included in assembly 620 may be based on the number of second health service providers that are associated with the third health service provider. For example, if only one second health service provider is associated with the third health service provider, assembly 620 may only include one grouping 616. As another example, if three second health service providers are associated with the third health service provider, assembly 620 may include three groupings 616, as is illustrated by assembly 620. Assembly 620 may include any size and/or shape. As an example, assembly 620 may include the size and/or shape of all of the groupings 616 included in the assembly 620 (e.g., assembly 620 may have the size and/or shape of three groupings 616 when three groupings 616 are included in assembly 620). Furthermore, according to the illustrated embodiment, assembly 620 may be an arc of one or more of the groupings 616.

The information included in image 604 may be illustrated using one or more colors. For example, each of the groupings 616 (e.g., which represent a second health service provider) may be illustrated with a different color. In such an example, grouping 616a (e.g., which represents doctor B) may be illustrated with the color red, grouping 616b (e.g., which represents doctor C) may be illustrated with the color yellow, and grouping 616c (e.g., which represents doctor D) may be illustrated with the color blue. Furthermore, each of the sections 608 in a grouping 616 may be illustrated with a first shade of that color, and each of the first indications 612 in each of the sections 608 in a grouping 616 may be illustrated with a second shade of that color. As an example, each of the sections 608a-608d of grouping 616a may be illustrated with a “fire engine red” shade of red, and each of the status indications 612a-612d in each of the sections 608a-608d of grouping 616a may be illustrated with a “maroon” shade of red. As such, when a first health service provider (e.g., doctor A) is viewing image 604, the first health service provider may be able to more quickly understand how many patients have been referred to the second health service provider (e.g., doctor B), and also be able to more quickly understand the status of each of the patients referred to the second health service provider. Furthermore, assembly 620 may be illustrated with a combination of the colors of the groupings 616 included in assembly 620. For example, as is discussed above, when grouping 616a is red, grouping 616b is yellow, and grouping 616c is blue, assembly 620 may be illustrated with each of the colors red, yellow, and blue.

Current summary report 624 may represent a summary of information. For example, current summary report 624 may represent a summary of information associated with referrals made by the first health service provider (e.g., Doctor A). As illustrated, current summary report 624 may identify a number of second health service providers that the first heath service provider has referred patients to (e.g., doctor A has referred patients to 10 different doctors), a number of patients that have been referred to second health service providers (e.g., doctor A has referred 16 patients to doctors), an average time to visit for the patient (e.g., the average amount of time between when the patient scheduled an appointment with the second health service provider and when the appointment actually occurs), an average time waiting for the patient (e.g., the average amount of time between an acknowledgment of the referral by second health service provider and the time when the patient scheduled an appointment), any other information associated with referrals made by the first health service provider, or any combination of the preceding. Furthermore, the information included in current summary report 624 may change colors based on the content of the information. For example, if a particular number included in current summary report 624 is low, the number may be illustrated as green. On the other hand, if the number is high, the number may be illustrated as red. In such an example, if the average time to visit of a patient is low (e.g., two days), it may be illustrated as green. But, if the average time to visit of a patient is high (e.g., 15 days), it may be illustrated as red.

Selected summary report 628 may represent information associated with a selected portion of image 604. For example, when reviewing graphical user interface 600, a first health service provider (or any other user of user device 54), may click on (or otherwise select) a particular portion of the image 604 (e.g., the first health service provider may select a particular second health service provider or a grouping associated with the second health service provider). In such an example, selected summary report 628 may illustrate a summary of information associated with the selected portion of image 604 (e.g., it may illustrate a summary of information associated with the selected second health service provider). Selected summary report 628 may illustrate a summary of any type of information associated with the selected portion of image 604. For example, when a second health service provider is selected, selected summary report 628 may illustrate identifying information for the second health service provider, contact information for the second health service provider, the number of patients that have been referred to the second health service provider, the second health service provider's average time to visit, the second health service provider's average time waiting, any other information associated with the second health service provider, or any combination of the preceding. As another example, when a particular patient is selected (e.g., by selecting a particular section 608), selected summary report 628 may illustrate identifying information for the patient, contact information for the patient, the status associated with the patient, the patient's time to visit, the patient's time waiting, any other information associated with the patient, or any combination of the preceding. Furthermore, similar to current summary report 624, the information in selected summary report 628 may change colors based on the content of the information.

Referral list 632 may represent a list of referrals provided by the first health service provider. For example, referral list 632 may include information associated with one or more of the referrals (or all of the referrals) made by the first health service provider. Similar to current summary report 624 and selected summary report 628, the information in referral list 632 may change colors based on the content of the information. Referral list 632 may include referral section 636, status section 640, waiting section 644, message section 648, acknowledgement section 652, and tool button 656.

Referral section 636 may include information associated with a particular referral. For example, referral section 636 may include an identifier of the patient that was referred, an identifier of the second health service provider to which the patient was referred, any other information associated with a particular referral, or any combination of the preceding.

Status section 640 may illustrate the status associated with the patient. For example, similar to status indication 612, status section 640 may illustrate the current status of the patient with regard to a particular referral. According to the illustrated embodiment, status section 640 may illustrate the status associated with the patient as being one of a plurality of stages (e.g., stage A, stage B, stage C, stage D, etc.). The status illustrated in status section 640 may correspond to the status illustrated in image 604 by status indication 612.

Waiting section 644 may represent an indication of an amount of time the patient is waiting with regard to the referral. For example, waiting section 644 may illustrate the time to visit for the patient (e.g., the amount of time between when the patient scheduled an appointment with the second health service provider and when the appointment actually occurs), the time waiting for the patient (e.g., the amount of time between an acknowledgment of the referral by second health service provider and the time when the patient schedules an appointment), any other wait period for the patient, or any combination of the preceding. Furthermore, waiting section 644 may adjust based on the status associated with the patient. For example, after the patient schedules an appointment with the second health service provider, waiting section 644 may switch from illustrating the time waiting for the patient to illustrating the time to visit for the patient.

Message section 648 may represent an indication and/or link to messages associated with the referral. As an example, message section 648 may indicate the number of messages that have been sent to (and/or from) a second health service provider with regard to the referral. Furthermore, message section 648 may further provide a link that may be clicked on (or otherwise selected) in order to access each of the messages.

Acknowledgement section 652 may represent an illustration of whether or not the second health service provider has acknowledged the referral. For example, the first health service provider may have referred a patient to the second health service provider by sending a referral communication (e.g., e-mail) to the second health service provider. Such a referral communication may include information associated with the patient (e.g., reports 38 for the patient) and may further include a link that may be clicked on (or otherwise selected) that may allow the second health service provider to acknowledge that the second health service provider is willing to provide health services to the patient. If the second health service provider has acknowledged the referral, acknowledgement section 652 may indicate such an acknowledgement. (e.g., “yes” or a green check mark). On the other hand, if the second health service provider has not acknowledged the referral, acknowledgement section 652 may indicate that the acknowledgement has not yet occurred (e.g., “no” or red “x” mark).

Tool Section 656 may represent a button (or any other type of link) that may allow the first health service provider to revoke a referral. For example, if the first health service provider determines that they no longer want to refer a patient to the second health service provider, the first health service provider may click on (or otherwise select) the button in tool section 656 to revoke the referral. Such a revocation may remove the referral from referral list 632 and/or image 604.

As is discussed above, a first health service provider may refer one or more patients to a second health service provider. Such a referral of patients may occur in any manner. As an example, the first health service provider may click on (or otherwise select) the send button 660 illustrated in graphical user interface 600. Following such a selection, the first user provider may be directed through a series of steps associated with the referral. For example, in the first step, the first health service provider may select a patient that the first health service provider would like to refer to a second health service provider. In such an example, if the first health service provider would like to refer patient A to a second health service provider, the first health service provider may select patient A. In the second step, the first health service provider may select a second health service provider to which the first health service provider would like to refer the patient to. For example, if the first health service provider would like to refer patient A to doctor B, the first health service provider may select doctor B. In the third step, the first health service provider may select one or more reports 38 (or content 104) to include with the referral. As an example, if the first health service provider is referring patient A to doctor B so that doctor B can examine patient A's broken leg, the first health service provider may only select reports 38 that include a classification 148 of “broken leg”. Such a selection may cause only the selected reports 38 to be included in the referral. On the other hand, while all reports 38 for patient A may be included in the referral, such a selection may cause only the selected reports 38 to be highlighted for review in the referral. In the fourth step, the first health service provider may add a message to the referral. For example, if the first health service provider is referring patient A to doctor B so that doctor B can examine patient A's broken leg, the first health service provider may input a message to doctor B regarding patient A's broken leg. After the first health service provider has completed each of the four steps, the referral message may be sent to the second health service provider.

Once the second health service provider receives the referral message from the first health service provider, the second health service provider may access and view the information included in the referral message. However, in particular embodiments, access and view of the information may still be subject to permission levels 42 (discussed above). For example, doctor B may be unable to access and view particular information without receiving a corresponding permission level 42 from patient A. As another example, by receiving the referral message from the first health service provider, doctor B may also receive a corresponding permission level 42 from the first health service provider.

Although graphical user interface 600 (and image 604) has been described above as providing patient status information associated with the referral of patients from a first health service provider to one or more second health service providers, graphical user interface 600 (and image 604) may provide any other information regarding a status associated with a patient. As a first example, graphical user interface 600 (and image 604) may provide patient status information associated with the referral of patients from second or third health service providers to the first health service provider. As such, the first health service provider may be able to understand which second and third health service providers have referred patients to the first health service provider. Furthermore, the first health service provider may be able to understand the status associated with each of the patients that have been referred to the first health service provider.

As a second example, graphical user interface 600 (and image 604) may provide information associated with the status of treatment of a patient by a health service provider. In such an example, a hospital (or other medical facility) may utilize graphical user interface 600 (and image 604) in order to manage and view the number of patients being treated by each of its doctors (and/or other medical professionals) in the hospital. Furthermore, the status associated with each of the patients may refer to the status of the patient in such a treatment (e.g., if the patient is undergoing surgery in the hospital, the status of each patient may include the following stages: check-in, pre-operation, operation, post-operation, check out, and/or follow up after check out).

As a further example of this, a medical testing provider may utilize graphical user interface 600 (and image 604) to manage and view information associated with the status of the testing of the patient's samples (e.g., how far along the testing is, which employee is conducting the testing). Furthermore, the status associated with each of the patients may refer to the status of the testing of the patient's sample (e.g., the status may include the following stages: acknowledgement of receipt of the sample, preparation of the sample for testing, testing of the sample, diagnosis complete, and/or report on testing ready).

As an additional example of this, a pharmacy may utilize graphical user interface 600 (and image 604) to manage and view information associated with the status of a patient's prescription (e.g., how far along preparation of the prescription is, which employee is conducting the preparation). Furthermore, the status associated with each of the patients may refer to the status of the preparation of the patient's prescription (e.g., the status may include the following stages: acknowledgment of receipt of a prescription, preparation of the prescription, prescription is ready, prescription has been delivered to the patient, and/or patient has requested a refill of the prescription).

Modifications, additions, or omissions may be made to graphical user interface 600 without departing from the scope of the disclosure. For example, although graphical user interface 600 has been described as including particular information, graphical user interface 600 may include more or less information. For example, graphical user interface 600 may include any other information regarding the patient, the first health service provider, the second health service provider, and/or the third health service provider.

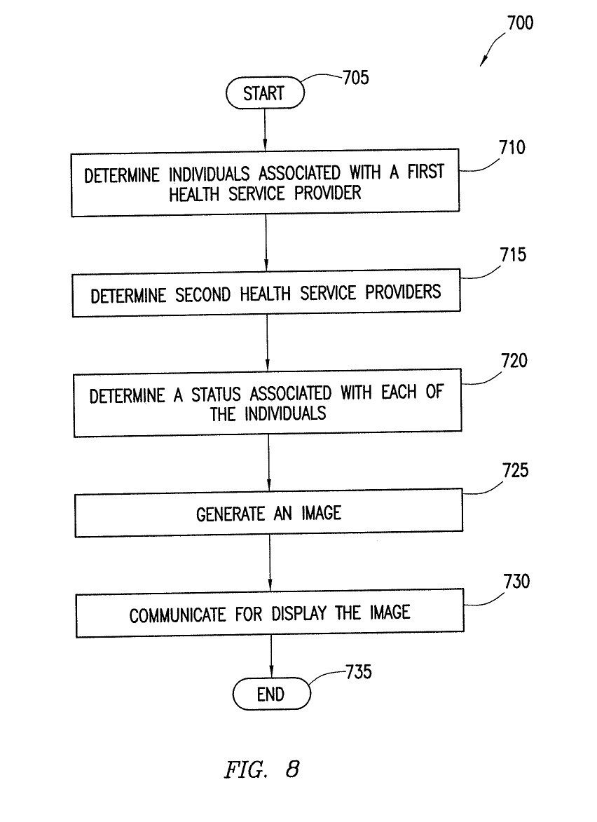

FIG. 8 illustrates a method for generation of an image regarding statuses associated with patients according to one embodiment of this disclosure. One or more steps of method 700 may be performed by management device 14. For example, one or more steps of method 700 may be performed in accordance with the description of one or more of FIGS. 1-7.

The method 700 begins at step 705. At step 710, one or more individuals associated with a first health service provider are determined. The individuals may be associated with the first health service provider in any manner. For example, the individuals may be patients of the first health service provider. As another example, the individuals may be patients that the first health service provider has referred to a second health service provider. The individuals may be determined in any manner. As an example, management device 14 may track the identity of individuals referred by the first health service provider to a second health service provider (e.g., by tracking reports 38, referral communications, etc.). As such, the individuals may be determined based on such tracking. As a further example, a user of user device 54 may input the identity of individuals referred by the first health service provider. As such, the individuals may be determined based on such an input.

At step 715, second health service providers are determined. The second health service providers may be associated with at least one of the individuals. For example, one of the individuals may have been referred to one of the second health service providers. The second health service providers may be determined in any manner. As an example, management device 14 may track the identity of second health service provider to which one or more patients are referred to by first health service provider (e.g., by tracking reports 38, referral communications, etc.). As such, the individuals may be determined based on such tracking. As a further example, a user of user device 54 may input the identity of second health service providers to which one or more patients are referred to by first health service provider. As such, the individuals may be determined based on such an input.

At step 720, a status associated with each of the individuals is determined. The status associated with an individual may refer to any type of status. For example, the status may be associated with a referral of an individual to a health service provider. As another example, the status may be associated with a health service procedure being performed on or for an individual (e.g., an operation, testing of a sample of an individual, preparation of a prescription for an individual, etc.). The status may include one or more stages. As an example, the status associated with a referral of an individual to a health service provider may include the following stages: an acknowledgment status, an appointment status, an information reviewed status, an appointment completed status, any other status, or any combination of the preceding. As another example, the status associated with a health service procedure being performed on or for an individual may include the following stages: check-in, pre-operation, operation, post-operation, check out, follow up after check out, any other status, or any combination of the preceding.

The status associated with an individual may be determined in any manner. As an example, the status may be determined based on one or more communications between the first health service provider, the second health service providers, and/or the third health service providers (e.g., via management device 14). In such an example, an acknowledgement status of an individual may be determined based on the second health service provider choosing to select an acknowledgement button (or any other type of link) included in a referral message. By selecting the acknowledgement message button, a communication may be provided to management device 14 indicating that a referral has been acknowledged. Therefore, management device 14 may determine that the individual is associated with acknowledgement status. As a further example of this, a status of an individual may be determined based on one or more reports 38 (or content 104 communicated to management device 14 in a clinical packet 100). In such an example, when a health service provider has provided a diagnosis for the individual, the health service provider may communicate content 104 including such a diagnosis in clinical packet 100 to management device 14. Therefore, the content 104 (and/or the report 38 created using content 104) may allow management device 14 to determine the status associated with the individual. As another example, a user of user device 54 (e.g., a first health service provider, a second health service provider, and/or a third health service provider) may input the status associated with an individual. In such an example, when a patient has scheduled an appointment with the second health service provider, the second health service provider may utilize user device 54 and graphical user interface 58 to manually change the status associated with an individual. As a further example of this, the appointment calendar of the second health service provider may automatically sync with management device 14, causing the status associated with an individual to be automatically changed.

At step 725, an image is generated. The image may be any image that illustrates information regarding statuses associated with patients. As an example, the image may be image 604 of FIGS. 7A-7B. Furthermore, the image may include any of the information discussed above with regard to FIGS. 7A-7B. For example, the image may include one or more sections (e.g., section 608) representing one of the individuals. Furthermore, each of the sections may include an indication (e.g., status indication 612) of the status associated with the individual. Such an indication may be provided in the section. Furthermore, the image may include groupings (e.g., grouping 616) of one or more sections. Each of these groupings may represent one of the second health service providers. Additionally, the image may further include one or more assemblies (e.g., assembly 620) of one or more of the groupings. Each of these grouping may represent one or more third health service providers.

The image may be generated based on the individuals, the second health service providers, and the statuses associated with the individuals. As such, the image may include information associated with the individuals, the second health service providers, and the statuses associated with the individuals.

At step 730, the image is communicated for display. For example, the image may be communicated for display to user device 54 as graphical user interface 58 (and/or graphical user interface 600). At step 735, the method ends.

The steps illustrated in FIG. 8 may combined, modified, or deleted where appropriate. Additionally, the described steps may be performed in any order. Furthermore, additional steps may also be added to the example operation. As an example, method 700 may further include one or more steps where a change in the status associated with an individual is determined. For example, management device 14 may determine that the status associated with an individual has moved from a first stage to a second stage (e.g., moved from an acknowledgment status to an appointment status). In such an example, the generated image may be updated to indicate the change in the status, and the updated image may be communicated for display. As an example, when the status of an individual is determined to have changed, status indication 612 of FIGS. 7A-7B may be updated to indicate such a change in status (e.g., status indication 612 may be updated to fill in a larger portion of section 608 than before the status was determined to have changed). As such, the image may now indicate that the status has changed. As an additional example, method 700 may further include one or more steps where third health service providers are determined. Such a determination may be made in any manner. For example, the determination may be made based on the determined second health service providers (e.g., management device 14 may include information that identifies each third service provider associated with a second health service provider). As another example, the determination may be made based on an input of the identity of the third service provider using user device 54.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a memory;
one or more processors communicatively coupled to the memory and operable to:
determine a plurality of individuals associated with a first health service provider;
determine a plurality of second health service providers that are each associated with at least one of the individuals;
determine a status associated with each of the individuals;
generate an image based on the individuals, the second health service providers, and the statuses associated with the individuals, the image comprising:
a plurality of sections that each represent one of the individuals, each section including an indication in the section of the status associated with the one of the individuals; and
a plurality of groupings of one or more of the sections, each grouping representing one of the second health service providers; and
communicate for display the image.

2. The system of claim 1, wherein the one or more processors are further operable to determine one or more third health service providers that are each associated with at least one of the individuals and at least one of the second health service providers, wherein the image further comprises an assembly of one or more of the groupings, each assembly representing one of the third health service providers.

3. The system of claim 1, wherein:
the image comprises a pie chart;
each section comprises a sector of the pie chart; and
each grouping comprises an arc of one or more of the sectors of the pie chart.

4. The system of claim 1, wherein the one or more processors are further operable to:
determine that the status associated with a first individual has changed;
update the image to indicate the change in the status associated with the first individual; and
communicate for display the updated image.

5. The system of claim 1, wherein the individuals comprise patients of the first health service provider that have been referred to at least one of the second health service providers by the first health service provider.

6. The system of claim 1, wherein:
each of the second health providers is associated with a different color;
each of the sections included in the grouping representing a respective second health service provider comprise a first shade of the respective color; and
each of the indications in each of the sections included in the grouping representing the respective second health service provider comprise a second shade of the respective color.

7. The system of claim 1, wherein:
the status of a respective individual comprises one of a plurality of stages;
in a first stage of the plurality of stages, the respective indication fills in a first portion of the respective section;
in a second stage of the plurality of stages, the respective indication fills in a second portion of the respective section, wherein the second portion is greater than the first portion; and
in a third stage of the plurality of stages, the respective indication fills in a third portion of the respective section, wherein the third portion is greater than the second portion.

8. A non-transitory computer readable medium comprising logic, the logic, when executed by a processor, operable to:
determine a plurality of individuals associated with a first health service provider;
determine a plurality of second health service providers that are each associated with at least one of the individuals;
determine a status associated with each of the individuals;
generate an image based on the individuals, the second health service providers, and the statuses associated with the individuals, the image comprising:
a plurality of sections that each represent one of the individuals, each section including an indication in the section of the status associated with the one of the individuals; and
a plurality of groupings of one or more of the sections, each grouping representing one of the second health service providers; and
communicate for display the image.

9. The computer readable medium of claim 8, wherein the logic, when executed by the processor, is further operable to determine one or more third health service providers that are each associated with at least one of the individuals and at least one of the second health service providers, wherein the image further comprises an assembly of one or more of the groupings, each assembly representing one of the third health service providers.

10. The computer readable medium of claim 8, wherein:
the image comprises a pie chart;
each section comprises a sector of the pie chart; and
each grouping comprises an arc of one or more of the sectors of the pie chart.

11. The computer readable medium of claim 8, wherein the logic, when executed by the processor, is further operable to:
determine that the status associated with a first individual has changed;
update the image to indicate the change in the status associated with the first individual; and
communicate for display the updated image.

12. The computer readable medium of claim 8, wherein:
each of the second health providers is associated with a different color;
each of the sections included in the grouping representing a respective second health service provider comprise a first shade of the respective color; and
each of the indications in each of the sections included in the grouping representing the respective second health service provider comprise a second shade of the respective color.

13. The computer readable medium of claim 8, wherein:
the status of a respective individual comprises one of a plurality of stages;
in a first stage of the plurality of stages, the respective indication fills in a first portion of the respective section;
in a second stage of the plurality of stages, the respective indication fills in a second portion of the respective section, wherein the second portion is greater than the first portion; and
in a third stage of the plurality of stages, the respective indication fills in a third portion of the respective section, wherein the third portion is greater than the second portion.

14. A method, comprising:
determining, by one or more processors, a plurality of individuals associated with a first health service provider;
determining, by the one or more processors, a plurality of second health service providers that are each associated with at least one of the individuals;
determining, by the one or more processors, a status associated with each of the individuals;
generating, by the one or more processors, an image based on the individuals, the second health service providers, and the statuses associated with the individuals, the image comprising:
a plurality of sections that each represent one of the individuals, each section including an indication in the section of the status associated with the one of the individuals; and
a plurality of groupings of one or more of the sections, each grouping representing one of the second health service providers; and
communicating, by the one or more processors, for display the image.

15. The method of claim 14, further comprising determining, by the one or more processors, one or more third health service providers that are each associated with at least one of the individuals and at least one of the second health service providers, wherein the image further comprises an assembly of one or more of the groupings, each assembly representing one of the third health service providers.

16. The method of claim 14, wherein:
the image comprises a pie chart;
each section comprises a sector of the pie chart; and
each grouping comprises an arc of one or more of the sectors of the pie chart.

17. The method of claim 14, further comprising:
determining, by the one or more processors, that the status associated with a first individual has changed;
updating, by the one or more processors, the image to indicate the change in the status associated with the first individual; and
communicating, by the one or more processors, for display the updated image.

18. The method of claim 14, wherein the individuals comprise patients of the first health service provider that have been referred to at least one of the second health service providers by the first health service provider.

19. The method of claim 14, wherein:
each of the second health providers is associated with a different color;
each of the sections included in the grouping representing a respective second health service provider comprise a first shade of the respective color; and
each of the indications in each of the sections included in the grouping representing the respective second health service provider comprise a second shade of the respective color.

20. The method of claim 14, wherein:
the status of a respective individual comprises one of a plurality of stages;
in a first stage of the plurality of stages, the respective indication fills in a first portion of the respective section;
in a second stage of the plurality of stages, the respective indication fills in a second portion of the respective section, wherein the second portion is greater than the first portion; and
in a third stage of the plurality of stages, the respective indication fills in a third portion of the respective section, wherein the third portion is greater than the second portion.
